(19) United States
(12) Patent Application Publication
(10) Pub. No.: US 2011/0060800 A1
(43) Pub. Date: Mar. 10, 2011

(54) METHOD OF GUARANTEEING THE DELIVERABILITY OF EMAILS AND OTHER MESSAGES

(75) Inventors: Ram Cohen, Tel Aviv (IL); Aryeh Mergi, Bazra (IL)

(73) Assignee: ACTIVEPATH LTD., PETAH-TIQVA (IL)

(21) Appl. No.: 12/876,384

(22) Filed: Sep. 7, 2010

Related U.S. Application Data
(60) Provisional application No. 61/240,668, filed on Sep. 9, 2009.

(51) Int. Cl. G06F 15/16

(52) U.S. Cl. 709/206

(57) ABSTRACT

Systems, methods, computer program products, and networks for messaging including sending, receiving and/or tracking messages. In some cases tracking may include updating receipt statuses of sent messages for which receipt notifications were received. In some cases, additionally or alternatively, tracking may include resending messages for which receipt notifications were not received. In some cases, additionally or alternatively, tracking may include receiving receipt notifications for messages which indicate one or more characteristics of the respective receiving systems.

### CROSS REFERENCE TO RELATED APPLICATION

This application claims the benefit of U.S. Provisional Application No. 61/240,668, filed on Sep. 9, 2009, which is hereby incorporated by reference herein.

### FIELD OF THE INVENTION

The present invention relates to the field of messaging.

### BACKGROUND OF THE INVENTION

Although messaging has become a popular method of communication, it still lacks a reliable mechanism to ensure receipt of messages. There are numerous possible reasons why a message may not be received. For example, if a message is suspected of being a spam message, the message may be blocked by an intermediate server, in many cases without the knowledge of the sending user and/or intended receiving user(s) of the message.

### SUMMARY OF THE INVENTION

According to some embodiments of the invention, there is provided a system for tracking sent messages, comprising: a communicator operable to receive receipt notifications for sent messages; an accessor operable to update receipt statuses of the messages; and a follow up action performer operable to perform at least one action relating to at least one sent message for which a receipt notification was not received.

According to some embodiments of the invention, there is also provided a system for tracking a sent message, comprising: a communicator operable to receive a receipt notification for a sent message, the notification including an indication of at least one characteristic of a receiving system which received the message.

According to some embodiments of the invention, there is further provided a system for receiving a message, comprising: a tracking information determiner operable to determine where to send a message receipt notification for a received message which is being tracked so that receipt status will be updated; and a notification composer operable to compose the receipt notification, including an indication of at least one characteristic of the system, and operable to send the composed receipt notification to where tracking information determiner determined.

According to some embodiments of the invention, there is still further provided a system for receiving messages, comprising: a tracking information determiner operable to determine where to send receipt notifications for received messages which are being tracked so that receipt statuses will be updated for corresponding messages; a notification composer operable to compose the receipt notifications and to send the composed receipt notifications to where tracking information determiner determined; and a request handler operable to handle requests to a tracking system, the requests triggering actions relating to non-received messages intended for a receiving user associated with the receiving system.

According to some embodiments of the invention, there is provided a network for messaging, comprising: a receiving system operable to receive a message which is being tracked and to send a receipt notification for the message; and a tracking system operable to receive the receipt notification and update receipt status for the message, and further operable to perform at least one action relating to at least one sent message for which a receipt notification was not received.

According to some embodiments of the invention, there is also provided a network for messaging, comprising: a receiving system operable to receive a message which is being tracked and to send a receipt notification for the message, the notification including an indication of at least one characteristic of the receiving system; and a tracking system operable to receive the notification.

According to some embodiments of the invention, there is further provided a method of tracking sent messages, comprising: becoming aware of messages sent by a sending system; updating receipt statuses of sent messages for which receipt notifications have been received; and upon a trigger, performing at least one action relating to sent messages for which receipt notifications have not been received.

According to some embodiments of the invention, there is still further provided a method of tracking a sent message, comprising: receiving a receipt notification for a sent message, the notification including an indication of at least one characteristic of a receiving system which received the message.

According to some embodiments of the invention, there is provided a method of receiving a message, comprising: determining where to send a message receipt notification for a received message which is being tracked so that receipt status will be updated; composing the receipt notification, including an indication of at least one characteristic of the system; and sending the composed receipt notification to where determined.

According to some embodiments of the invention, there is also provided a method of receiving messages, comprising: a receiving system receiving messages and sending receipt notifications for received messages; sending a request to receive any messages which were sent but not received; and receiving the previously non-received messages subsequent to the request.

According to some embodiments of the invention, there is further provided a method of messaging, comprising: a receiving system receiving a message which is being tracked and sending a receipt notification for the message; receiving the receipt notification and updating receipt status for the message; and performing at least one follow up action relating to at least one sent message for which a receipt notification was not received.

According to some embodiments of the invention, there is still further provided a method of messaging, comprising: receiving a message which is being tracked; sending a receipt notification for the message, the notification including an indication of at least one characteristic of a receiving system which received the message; and receiving the receipt notification.

According to some embodiments of the invention, there is provided a computer program product comprising a machine useable medium having machine readable program code embodied therein for tracking sent messages, the computer program product comprising: machine readable program code for causing the machine to become aware of messages sent by a sending system; machine readable program code for causing the machine to update receipt statuses of sent messages for which receipt notifications have been received; and machine readable program code for causing the machine upon a trigger, to perform at least one action relating to sent messages for which receipt notifications have not been received.

According to some embodiments of the invention, there is also provided a computer program product comprising a machine useable medium having machine readable program code embodied therein for tracking a sent message, the computer program product comprising: machine readable program code for causing the machine to receive a receipt notification for a sent message, the notification including an indication of at least one characteristic of a receiving system which received the message.

According to some embodiments of the invention, there is further provided a computer program product comprising a machine useable medium having machine readable program code embodied therein for receiving a message, the computer program product comprising: machine readable program code for causing the machine to determine where to send a message receipt notification for a received message which is being tracked so that receipt status will be updated; machine readable program code for causing the machine to compose the receipt notification, including an indication of at least one characteristic of the system; and machine readable program code for causing the machine to send the composed receipt notification to where determined.

According to some embodiments of the invention, there is still further provided a computer program product comprising a machine useable medium having machine readable program code embodied therein for receiving messages, the computer program product comprising: machine readable program code for causing the machine to receive messages and send receipt notifications for received messages; machine readable program code for causing the machine to send a request to receive any messages which were sent but not received; and machine readable program code for causing the machine to receive the previously non-received messages subsequent to the request.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a high level block diagram of a network for messaging, according to some embodiments of the invention;

FIG. 2 is a more detailed block diagram of a sending system, according to some embodiments of the invention;

FIG. 3 is a flowchart illustration of a method of sending messages, according to some embodiments of the invention;

FIG. 4 is a more detailed block diagram of a tracking system, according to some embodiments of the invention;

FIG. 5 is a flowchart illustration of a method of enabling later access to data on sent messages, according to some embodiments of the invention;

FIG. 6 is a more detailed block diagram of a receiving system, according to some embodiments of the invention;

FIG. 7 is a flowchart illustration of a method of receiving messages, according to some embodiments of the invention;

FIG. 8 is a flowchart illustration of a method of updating receipt statuses of messages, according to some embodiments of the invention;

FIG. 9 is a flowchart illustration of a method of performing follow up actions relating to sent messages, according to some embodiments of the invention; and

FIG. 10 is a flowchart illustration of a method of handling requests, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

Embodiments of the invention relate to networks, systems, methods, and/or computer program products for messaging, including sending, receiving and/or tracking messages. In some embodiments tracking may include updating receipt statuses of sent messages for which receipt notifications were received. In some embodiments, additionally or alternatively tracking may include resending messages for which receipt notifications were not received. In some embodiments, additionally or alternatively, tracking may include receiving receipt notifications for messages which indicate one or more characteristics of the respective receiving systems. In some embodiments, additionally or alternatively, messaging may include one or more other features.

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

As used herein, the phrase “for example,” “such as”, “for instance” and variants thereof describe non-limiting embodiments of the present invention.

As used herein, and unless explicitly stated otherwise, the term “memory” refers to any module for storing data for the short and/or long term, locally and/or remotely. Examples of memory include inter-alia: any type of disk including floppy disk, hard disk, optical disk, CD-ROMs, magnetic-optical disk, magnetic tape, flash memory, random access memory (RAMs), dynamic random access memory (DRAM), static random access memory (SRAM), read-only memory (ROMs), programmable read only memory PROM, electrically programmable read-only memory (EPROMs), electrically erasable and programmable read only memory (EEPROMs), magnetic card, optical card, any other type of media suitable for storing electronic instructions and capable of being coupled to a system bus, a combination of any of the above, etc.

Reference in the specification to “one embodiment”, “an embodiment”, “some embodiments”, “another embodiment”, “other embodiments”, “one instance”, “some instances”, “one case”, “some cases”, “other cases” or variants thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “other embodiments” one instance”, “some instances”, “one case”, “some cases”, “other cases” or variants thereof does not necessarily refer to the same embodiment(s).

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Unless specifically stated otherwise, as apparent from the following discussions, it is appreciated that throughout the specification discussions utilizing terms such as “accessing”, “receiving”, “deleting”, “determining”, “updating”, “performing”, “providing”, “sending”, “including”, “incorporating”, “improving”, “adding”, “modifying”, “saving”, “resending”, “reporting”, “identifying”, “forwarding” “recognizing”, “notifying”, “enabling”, “composing”, “triggering” “obtaining”, “causing”, “executing”, “allowing”, “deriving”, “using”, “handling”, “removing”, “storing”, “retrieving”, “concealing”, “compiling”, “tracking” or the like, refer to the action and/or processes of any combination of software, hardware and/or firmware. For example, these terms may refer in some cases to the action and/or processes of a programmable machine, that manipulates and/or transforms data represented as physical, such as electronic quantities, within the programmable machine's registers and/or memories into other data similarly represented as physical quantities within the programmable machine's memories, registers or other such information storage, transmission or display elements.

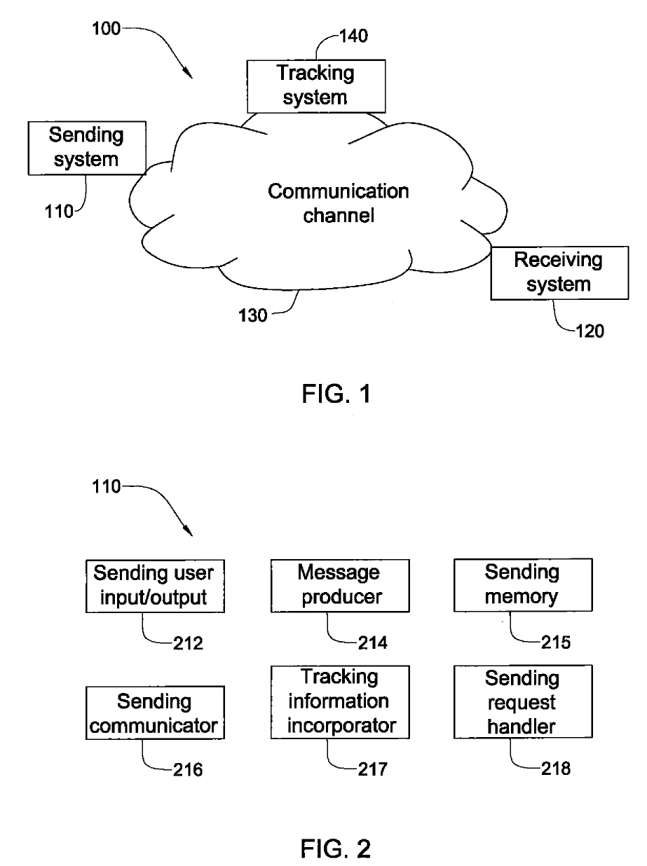

Referring now to the drawings, FIG. 1 illustrates a network 100 for messaging, according to some embodiments of the invention. In the illustrated embodiments, network 100 includes one or more sending systems 110 configured to send messages, one or more receiving systems 120 configured to receive messages, one or more tracking systems 140 configured to track messages and one or more communication channels 130. Embodiments of the invention do not limit the type(s) of messages transferred via network 100. Examples of types of messages include: email messages (e.g. web-based or desktop email client based), SMS, social network messages (e.g. Facebook messages, Twitter “tweets”, etc), instant messaging messages, a combination of the above, etc. Each sending system 110, receiving system 120 and/or tracking system 130 may be made up of any combination of hardware, software and/or firmware capable of performing the operations as defined and explained herein. For example, in some embodiments, any of sending system 110, receiving system 120 and/or tracking system 130 may comprise a machine specially constructed for the desired purposes, and/or may comprise a programmable machine selectively activated or reconfigured by specially constructed program code. For simplicity of description, tracking system 140, sending system 110, receiving system 120, and communication channel 130 are referred to below in the single form, but such reference should be construed to include embodiments with single and/or plural system(s)/channel(s), as appropriate for specific implementations and/or particular messages. For example, some embodiments of the invention are advantageous inter-alia because messages to a receiving user may be sent via different alternative communication channels.

Features of sending system 110 may vary depending on the embodiment. For example, in various embodiments sending system 110 may include a user device such as a personal computer, cell phone, smartphone, laptop, tablet computer, etc., may include element(s) which service multiple user devices such as proxy server(s), gateway(s), other types of servers, etc, and/or may include a combination of the above. Depending on the embodiment, modules in sending system 110 may be concentrated in the same location, for example in one unit or in various units in proximity of one another, or modules of sending system 110 may be dispersed over various locations.

Features of tracking system 140 may vary depending on the embodiment. For example, in some embodiments, tracking system 140 may reside anywhere in network 100, whereas in other embodiments, tracking system 140 resides in the same domain as sending system 110. In some embodiments, tracking system 140 comprises a gateway, proxy server, other type of server, any other element servicing multiple user devices, etc. Depending on the embodiment, modules in tracking system 140 may be concentrated in the same location, for example in one unit or in various units in proximity of one another, or modules of tracking system 140 may be dispersed over various locations.

Features of receiving system 120 may vary depending on the embodiment. For example, in various embodiments receiving system 120 may include a user device such as a personal computer, cell phone, smartphone, laptop, tablet computer, etc., may include element(s) which service multiple user devices such as proxy server(s), gateway(s), other types of servers, etc, and/or may include a combination of the above. Depending on the embodiment, modules in receiving system 120 may be concentrated in the same location, for example in one unit or in various units in proximity of one another, or modules of receiving system 120 may be dispersed over various locations.

Features of communication channel 130 may vary depending on the embodiment. For example, in various embodiments, communication channel 130 may comprise any suitable infrastructure for network 100 that provides direct or indirect connectivity between any of sending system 110, receiving system 120, and tracking system 140. Communication channel 130 may use for example one or more wired and/or wireless technology/ies. Examples of channel 130 include cellular network channel, personal area network channel, local area network channel, wide area network channel, internetwork channel, Internet channel, any combination of the above, etc.

In some embodiments, a particular location or locations may include a sending system such as system 110 and a receiving system such as system 120 which may or may not be integrated with one another. In these embodiments, the functionality of the particular location(s) with respect to sending and/or receiving may in some cases vary for different messages. In some embodiments, additionally or alternatively a specific location or locations may include only a sending system such as system 110 or only a receiving system such as system 120. In these embodiments, the messaging functionality of the specific location(s) with respect to sending or receiving is unvarying.

FIG. 2 is a block diagram of sending system 110, according to some embodiments of the invention. In the illustrated embodiments, sending system 110 includes a sending user input/output 212 configured to receive data from a sending user associated with sending system 110 and/or present data to a sending user associated with sending system 110, a message producer 214 configured to produce a message using data received from a user, and a sending communicator 216 configured to communicate via channel 130. Optionally, sending system 110 may also include a tracking information incorporator 217 configured to incorporate tracking information in a message, a sending memory 215 configured to store data on sent messages, and/or a sending request handler 218 configured to handle requests. Sending system 110 includes at least some hardware and in various embodiments, each of sending user input/output 212, message producer 214, sending memory 215, sending communicator 216, tracking information incorporator 217 and/or sending request handler 218 may be made up of any combination of hardware, software and/or firmware capable of performing the operations as defined and explained herein. Examples of sending user input/output 212 include keyboard, mouse, keypad, touch-screen display, microphone, speaker, non-touch-screen display, and/or printer, etc. In some embodiments any of the modules in sending system 110 may be included in any of the following: a web browser; a mail client; an instant messaging client; a peer-to-peer application; a user interface; an SMS application; a messaging application; any other type of Internet client; a plug-in, an add-on, a toolbar or an applet for a browser or a mail client or an instant messaging client; a standalone client; any other suitable element servicing one user device; a gateway; a proxy server; any other type of server; and/or any other suitable element servicing multiple user devices, etc.

In some embodiments, sending system 110 may comprise fewer, more, and/or different modules than those shown in FIG. 2. In some embodiments, the functionality of sending system 110 described herein may be divided differently among the modules of FIG. 2. In some embodiments, the functionality of sending system 110 described herein may be divided into fewer, more and/or different modules than shown in FIG. 2 and/or sending system 110 may include additional, less and/or different functionality than described herein. For example, sending system 110 may include other module(s) for sending messages in addition to or instead of one or more of the modules illustrated in FIG. 2. Depending on the embodiment modules in sending system 110 may be concentrated in one unit or separated among two or more units. For example, sending system 110 may include an embedded display or a detached display when input/output 212 includes a display. As another example, additionally or alternatively, in some cases, sending system 110 may be divided into two sub-systems, with a first subsystem including for example sending user input/output 212, message producer 214, and optionally a communicator to communicate with the second subsystem, and the second subsystem including for example sending communicator 216 and optionally tracking information incorporator 217, sending memory 215, and/or sending request handler 218. In these embodiments, the two subsystems may or may not be located at the same location. As another example, additionally or alternatively, in some cases two or more of the modules in sending system 110 may be divided between a first element such as a web browser, an email client, an instant messaging client, a peer-to-peer application, a user interface, an SMS application, a messaging application, any other type of Internet client, any other suitable element servicing one user device, a gateway, a proxy server, any other type of server and/or any other suitable element servicing multiple user devices, and a second element such as an applet, toolbar, plug-in or add-on to the first element, a standalone element associated with one user device, a gateway, a proxy server, any other type of server and/or any other standalone element servicing multiple user devices. In these embodiments, the two elements may or may not be located at the same location.

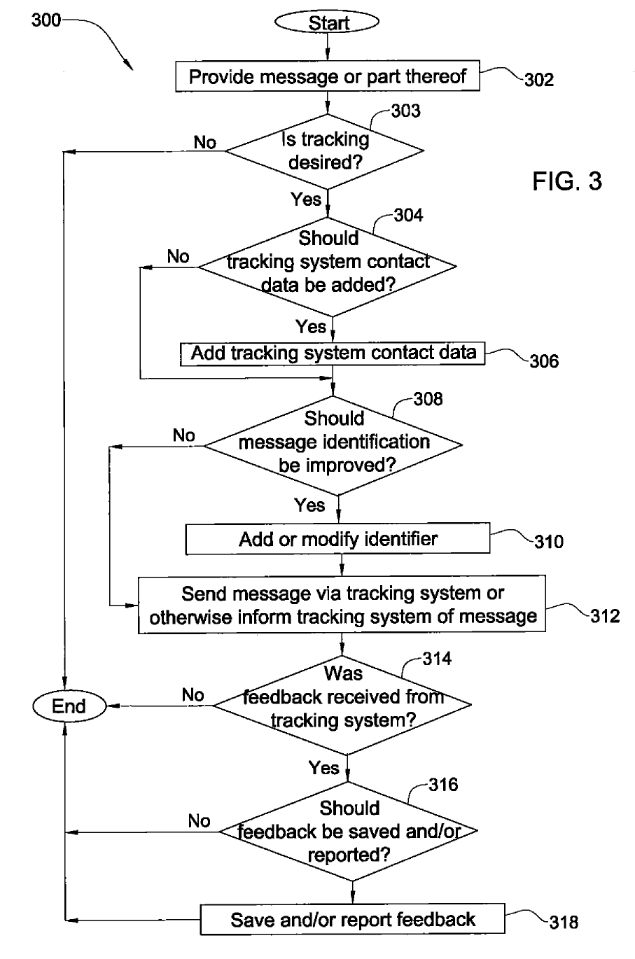

FIG. 3 is a flowchart of a method 300 of sending messages, according to some embodiments of the invention. Method 300 is performed in some embodiments by sending system 110. In some cases, method 300 may include fewer, more and/or different stages than illustrated in FIG. 3, the stages may be executed in a different order than shown in FIG. 3, and/or stages that are illustrated as being executed sequentially may be executed in parallel.

In the illustrated embodiments in stage 302, a message or a part thereof is provided. For example, message producer 214 may produce a message based on user input which was received via sending user input/output 212. In this example, the produced message may be provided to sending communicator 216 or to tracking information incorporator 217 for additional handling once the user has indicated via sending user input/output 212 that the message should be sent. As another example, the provision of a part of the message may refer to the provision of the user input received via user input/output 212 to message producer 214 so that message producer 214 can produce the message.

In the illustrated embodiments, in optional stage 303 it is determined by sending system 110, for instance by tracking information incorporator 217, whether or not the message will be tracked. For example, there may be a possibility of tracking messages or not tracking messages. In some embodiments, the possibility of tracking may include tracking receipt by all or less than all intended receiving user(s) listed in all or less than all included message receiver field(s). For example in an email message, receiver field(s) listing intended receiving user(s) may include the “To” field and/or equivalent, the “CC” field and/or equivalent, and/or the “BCC” field and/or equivalent. In some embodiments, additionally or alternatively, the possibility of tracking may or may not be allowed depending on various message parameters such as the message contents, the sender of the message, address of the receiving user, whether the receiving user is or is not listed in a particular receiving field (e.g “to” field”, “cc” field, and/or “bcc” field), or any other message parameter.

If the determination is that the message will be tracked (yes to stage 303) then in the illustrated embodiments method 300 continues with stage 304. If the determination is that the message will not be tracked (no to stage 303) then in the illustrated embodiments method 300 ends and the message production and/or sending proceeds in a known manner. In some embodiments, stage 303 may be omitted, for instance if all messages sent by sending system 110 are tracked.

In the illustrated embodiments in optional stage 304, it is determined by sending system 110, for example by tracking information incorporator 217, whether or not tracking system contact data should be added. For example, stage 304 may be performed during the initial production of the message or during the additional handling after the user has indicated that the message be sent. In other embodiments, where tracking system contact data is never added by sending system 110, for example because the addition of tracking system contact data, if any, would be performed by tracking system 140, or because the addition is not necessary (for example because receiving system 120 would know where to send a receipt notification even if tracking system contact data is not added to the message as will be explained in more detail below), stages 304 and 306 may be omitted.

If the determination is that tracking system contact data should be added (yes to stage 304), then in the illustrated embodiments in stage 306, contact data for tracking system 140 is added by sending system 110, for instance by tracking information incorporator 217. For example, contact data may be generated by tracking information incorporator 217 and added to the message during the initial production of the message by message producer 214. As another example, tracking information incorporator 217 may add contact data to the previously produced message.

In some embodiments, in stage 306 the added tracking system contact data is included in one or more of the fields of the message which would typically, although not necessarily, be presented to a receiving user in a summary inbox list. For example, assuming that an inbox summary list includes message receiver field(s), a “From” field and/or equivalent, a “Subject” field and/or equivalent, and/or a “Date/Time” field and/or equivalent, the tracking system contact data may be located in one or more of the included receiver field(s), “From” field and/or equivalent, “Subject” field and/or equivalent, and/or “Date/Time” field and/or equivalent. In these embodiments, the added contact data is not necessarily presented to the receiving user, because receiving system 120 may in some cases conceal the added contact data as will be explained in more detail below. In other embodiments, the added contact data is not necessarily included in any particular part of the message.

Depending on the embodiment, the added tracking system contact data may include any suitable information which directly or indirectly allows for contacting tracking system 140. For example, in some embodiments, the tracking system contact data includes direct contact information which can be used to contact tracking system 140, for instance a uniform resource locator URL. In another example, additionally or alternatively, tracking system contact data includes (indirect) contact information (such as an identifier of tracking system 140) which allows receiving system 120 to look up direct tracking system contact information such as a URL, for instance in a look up table accessible by receiving system 120, as will be described in more detail further below.

If instead it is determined that tracking system contact data should not be added (no to stage 304), then in the illustrated embodiments stage 306 is omitted. For example in some embodiments, it may be decided not to add tracking system contact data for a particular message for instance because the addition of tracking system contact data, if any, would be performed by tracking system 140, or because the addition is not necessary (for example because receiving system 120 for the particular message would know where to send a receipt notification even if tracking system contact data was not added to the message as will be explained in more detail below).

In the illustrated embodiments in optional stage 308, it is determined by sending system 110, for example by tracking information incorporator 217, whether or not message identification should be improved. For example, stage 308 may be performed during the initial production of the message or during the additional handling after the user has indicated that the message should be sent. In other embodiments, where all message identification improvement would always be performed by tracking system 140 or no message identification improvement is ever performed by sending system 110 or tracking system 140, stages 308 and 310 may be omitted. For example, in some embodiments, no message identification improvement may be performed by sending system 110 or tracking system 140 because the data provided by the sending user and/or by message producer 214 (such as body of the message, name/contact data of sending user, name/contact data of receiving user(s), data/time, original message ID, and/or subject) may be sufficient to identify the message. As another example, additionally or alternatively, no message identification improvement may be performed by sending system 110 or tracking system 140 if messages provided in stage 302 always already have a satisfactory identifier located in the contents of the message.

If the determination is that the message identification should be improved (yes to stage 308), then in the illustrated embodiments in stage 310 a message identifier is added or modified by sending system 110, for instance by tracking information incorporator 217. For example, a message identifier may be generated by tracking information incorporator 217 and added to the message during the initial production of the message by message producer 214. As another example, where the produced message already has an identifier (such as the Message-ID of an email message), tracking information incorporator 217 may move or copy the existing value to a different location in the message, may modify the existing value, or may add a new identifier in addition to or instead of the existing identifier. As another example, where the produced message does not already have an identifier, tracking information incorporator 217 may add a message identifier to the message.

In some embodiments in stage 310, the added or modified identifier is included in one or more of the fields of the message which would typically, although not necessarily, be presented to a receiving user in a summary inbox list. For example, assuming that an inbox summary list includes message receiver field(s), a “From” field and/or equivalent, a “Subject” field and/or equivalent, and/or a “Date/Time” field and/or equivalent, the identifier may be located in one or more of the included receiver field(s), “From” field and/or equivalent, “Subject” field and/or equivalent, and/or “Date/Time” field and/or equivalent. In these embodiments, the identifier is not necessarily presented to the receiving user, because receiving system 120 may in some cases conceal the identifier as will be explained in more detail below. In other embodiments, the identifier is not necessarily included in any particular part of the message.

In some embodiments, the identifier added or modified in stage 310 is unique. In other embodiments the identifier is not necessarily unique and in some cases additional identifying information may be required to identify the message besides the identifier.

In the illustrated embodiments, if the determination is instead that the message identification should not be improved (no to stage 308) then stage 310 is skipped. For example the determination may be that message identification should not be improved because message identification improvement for this message will be performed by tracking system 140 or because no identification improvement for this message will be performed by sending system 110 or by tracking system 140. Continuing with this example, in some embodiments, no message identification improvement may be performed by sending system 110 or tracking system 140 because the data provided by the sending user and/or by message producer 214 (such as body of the message, name/contact data of sending user, name/contact data of receiving user(s), data/time, original message ID, and/or subject) may be sufficient to identify the message. In other embodiments of this example, additionally or alternatively, no message identification improvement may be performed by sending system 110 or tracking system 140 because the message provided in stage 302 may already have a satisfactory identifier located in the contents of the message.

In some embodiments, tracking contact data added in stage 306 and/or an identifier added or modified in stage 310 also serves as an indication that the message is being tracked. In some other embodiments (in addition to or instead of the added and/or modified tracking contact data and/or identifier), sending system 110, for instance tracking information incorporator 217, may add to the message in stage 306 or 310 a separate indication that the message is being tracked. For example, in some cases where tracking contact data is not added by sending system 110 nor added/modified by tracking system 140, and an identifier is not added and/or modified by sending system 110 nor by tracking system 140, a separate indication of tracking may be added instead. In still other embodiments, in some cases where tracking contact data is not added by sending system 110 nor added/modified by tracking system 140, and an identifier is not added and/or modified by sending system 110 nor by tracking system 140, a separate tracking indication may not be added, for example because receiving system 120 in any event knows that all messages are tracked.

In some embodiments, prior to being sent in stage 312, the message may optionally be protected by sending system 110. Protection may include any of the following: encryption, hashing using a one way function, digitally signing, and/or encoding, etc. The protection may have been performed during the initial production of the message, for instance by message producer 214 and/or during additional handling of the produced message after the user has indicated that the message be sent, for instance by tracking information incorporator 217. In other embodiments, the message may not be protected.

In some embodiments prior to sending the message via tracking system 140, or prior to sending a copy of the message or any data on the message to tracking system 140, tracking system 140 may optionally authenticate and/or identify sending system 110 and/or the sending user. For example, authentication may be achieved by sending system 110, for instance sending communicator 216, providing the correct password, user credentials, etc. In some cases of this example, authentication may be automatic, for instance by way of a remembered password or any other authentication item. In other cases of this example, authentication is performed additionally or alternatively through input by the sending user to sending system 110 (e.g. via sending user input/output 212), for instance a password or other authentication item. In other embodiments, authentication is not performed. For example authentication may in some cases not be required if tracking system 140 is in the same domain as sending system 110.

In the illustrated embodiments, in stage 312 sending system 110 informs tracking system 140 of the sent message. For instance, the message may be sent out by sending system 110, e.g. by sending communicator 216, via or not via tracking system 140. If the message is sent via tracking system 140 then the receipt of the message by tracking system 140 informs tracking system 140 of the message. If the message is not sent via tracking system 140, then tracking system 140 may be informed in a different manner that the message has been sent. For example, in some cases sending system 110 may send or otherwise make accessible a copy of the message to tracking system 140. In instances of stage 312 where the message or a copy of the message is provided to tracking system 140, sending system 110 thus makes accessible to tracking system 140 all of the data comprised in the sent message. As another example of informing in a different manner, in some cases sending system 110 may send or otherwise make accessible in stage 312 only some data on the sent message (and not all the data comprised in the sent message) to tracking system 140. Continuing with the latter example where only partial data is sent or made accessible, the partial data may include any of the following: data in “From” field and/or equivalent such as sending user contact information and/or name, data in one or more included message receiver field(s) such as receiving user(s) contact information and/or name(s), identifier, data in “subject” field and/or equivalent, data in “data/time” field and/or equivalent, etc.

In some embodiments where sending system 110 may inform tracking system 140 differently for different messages, sending system 110, for example sending communicator 216, may provide an indication to tracking system 140 when in stage 312 a message is being sent via tracking system 140. In these embodiments, tracking system 140 will thereby know to forward a message to the intended receiving user(s). Depending on the embodiment, the indication may be explicit or may be implicit. For example in embodiments with an implicit indication, an implicit indication may be provided by the quantity and/or contents of data sent or made accessible to tracking system 140.

In some embodiments, the same message may be sent to a plurality of intended receiving users. In some embodiments with a plurality of intended receiving users, stage 310 is repeated for each intended receiving user so that if an identifier is to be added/modified, the addition/modification is different for each intended receiving user. In these embodiments, if the message is to be sent directly to receiving users (and not via tracking system 140) then in some instances sending stage 312 includes repeating the sending for each message with a different identifier. In some cases of embodiments where the message is being sent directly or via tracking system 140 to a plurality of receiving users in stage 312, each pair of identifier and corresponding receiving user is sent or made accessible to tracking system 140 but any other data which is to be sent or made accessible to tracking system 140 need only be sent or made accessible once to tracking system. In other cases of these embodiments where the message is being sent directly or via tracking system 140 to a plurality of receiving users in stage 312, all data which is to be sent or made accessible to tracking system 140, may be sent or made accessible to tracking system 140 a plurality of times in stage 312 in accordance with the number of receiving users. In other embodiments, with a plurality of intended receiving users, stage 310 is not necessarily repeated for each receiving user. For example, if it is sufficient to know that one or less than all receiving users received the message then a different identifier corresponding to each receiving user may be unnecessary. Additionally or alternatively in another example, knowledge of which of the receiving users is acknowledging receipt may in some cases be otherwise obtained, for instance because a receipt notification includes information on the receiving user, and therefore a different identifier corresponding to each receiving user may be unnecessary. In these embodiments, stage 312 does not necessarily include a plurality of times that the same and/or different data is sent and/or made accessible to tracking system 140.

In some embodiments, before or after sending, data on the sent message may be optionally stored by sending system 110, for example in sending memory 215. Depending on the embodiment with storing, the stored data may include a copy of the message or only some of the data on the sent message (for example identifier, data in one or more included message receiver field(s) such as receiving user(s) contact information and/or name, data in subject field and/or equivalent, data in date/time field and/or equivalent, etc).

In the illustrated embodiments, in stage 314 it is determined by sending system 110, for example by sending communicator 216, if feedback was received regarding the sent message from tracking system 140. For example, in some cases feedback may be received if and when tracking system 140 forwards the message to receiving system 120. As another example, additionally or alternatively, feedback may relate to additions and/or modifications to the message made by tracking system 140, as will be described in more detail below. As another example, additionally or alternatively, feedback may be provided for a message sent not via tracking system 140 if no receipt notification was received, for instance within a predetermined time interval, so that sending system 110 can in some cases send a duplicate message. If no feedback was received from tracking system 140 relating to the sent message (no to stage 314) then method 300 ends.

If instead feedback was received from tracking system 140 relating to the sent message (yes to stage 314), then in the illustrated embodiments in stage 316 it is determined by sending system 110, for example by sending communicator 216, if the feedback should be stored and/or reported to the sending user. If feedback is not to be stored nor reported (no to stage 316), then in the illustrated embodiments method 300 ends.

If feedback instead is to be stored and/or reported (yes to stage 316), then in the illustrated embodiments in stage 318, the feedback is saved by sending system 110, for instance to sending memory 215, and/or the feedback is reported by sending system 110 to the sending user, for instance via sending user input/output 212. For example, if feedback from tracking system 140 relates to addition of or change to the message identifier, then the added or changed identifier may be saved for possible later usage by sending request handler 218, for instance in method 1000 described below. As another example, additionally or alternatively, in some cases where feedback from tracking system 140 includes confirmation that the message was forwarded by tracking system 140, user input/output 212 may only display an indication that the message was sent after confirmation from tracking system 140 was received.

In some embodiments, if the feedback relates to a message for which a duplicate will be sent by sending system 110, then method 300 sends a duplicate message instead of or in addition to executing stage 318. In some cases where a duplicate message is sent, the duplicate message may be protected. Protection may include any of the following: encryption, hashing using a one way function, digitally signing and/or encoding, etc. In other cases where a duplicate message is resent, the message may not be protected.

After stage 318, in the illustrated embodiments method 300 ends.

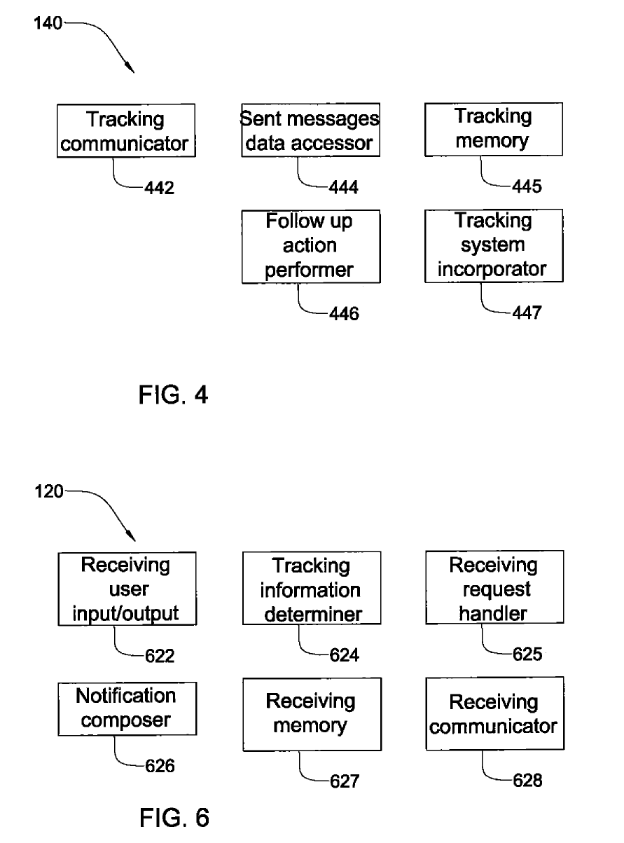

FIG. 4 is a block diagram of tracking system 140, according to some embodiments of the invention. In the illustrated embodiments, tracking system 140 includes a tracking communicator 442 configured to communicate via channel 130, a sent messages data accessor 444 configured to access data on sent messages including inter-alia configured to update receipt notifications on sent messages, and a follow up action performer 446 configured to manage follow up action on sent messages. Optionally tracking system 140 may also include a tracking memory 445 configured to store data on sent messages and/or a tracking system incorporator 447 configured to incorporate tracking information in a message. In various embodiments, each of tracking communicator 442, accessor 444, follow-up action performer 446, tracking memory 445 and/or tracking system incorporator 447 may be made up of any combination of hardware, software and/or firmware capable of performing the operations as defined and explained herein.

In some embodiments, tracking system 140 may comprise fewer, more, and/or different modules than those shown in FIG. 4. In some embodiments, the functionality of tracking system 140 described herein may be divided differently among the modules of FIG. 4. In some embodiments, the functionality of tracking system 140 described herein may be divided into fewer, more and/or different modules than shown in FIG. 4 and/or tracking system 140 may include additional, less and/or different functionality than described herein. For example, tracking system 140 may include other module(s) for tracking messages in addition to or instead of one or more of the modules illustrated in FIG. 4. As another example, tracking system 140 may additionally or alternatively include other module(s) unrelated to tracking messages in addition to or instead of one or more of the modules illustrated in FIG. 4. Depending on the embodiment modules in tracking system 140 may be concentrated in one unit or separated among two or more units.

In some embodiments, the tracking performed by tracking system 140 may include performing one or more stages described below with reference to method 500, one or more stages described below with reference to method 800 and/or one or more stages described below with reference to method 900. Optionally the tracking may additionally or alternatively include other operations not described with reference to any of these methods.

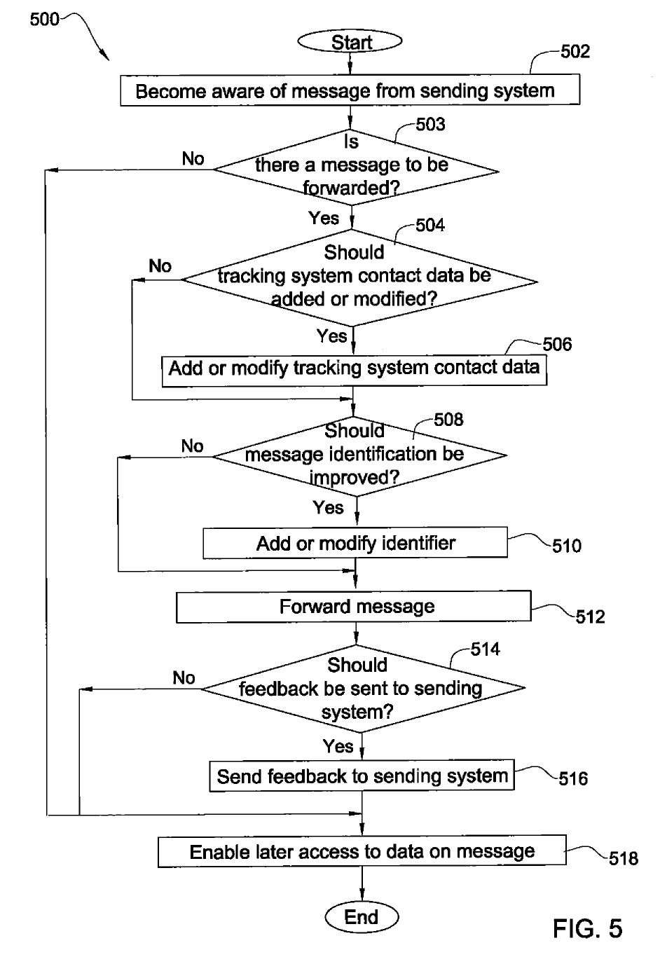

FIG. 5 is a flowchart of a method 500 of enabling later access to data on sent messages, according to some embodiments of the invention. Method 500 is performed in some embodiments by tracking system 140. In some cases, method 500 may include fewer, more and/or different stages than illustrated in FIG. 5, the stages may be executed in a different order than shown in FIG. 5, and/or stages that are illustrated as being executed sequentially may be executed in parallel.

In the illustrated embodiments in stage 502, tracking system 140, for example tracking communicator 442, becomes aware of a message sent by sending system 110. For example, sending system 110 may have sent the message via tracking system 140. As another example, sending system 110 may send or otherwise make accessible a copy of the message to tracking system 140. In these examples, all data comprised in the sent message becomes accessible to tracking system 140. As another example, in some cases sending system may send or otherwise make accessible only some data on the sent message (and not all the data comprised in the sent message) to tracking system 140. Continuing with the latter example where only partial data is sent or made accessible, the partial data may include any of the following: data in “From” field and/or equivalent such as sending user contact information and/or name, data in data in one or more included message receiver field(s) such as receiving user(s) contact information and/or name(s), identifier, data in subject field and/or equivalent, data in “date/time” field and/or equivalent, etc.

In some embodiments, prior to stage 502, tracking system 140, for instance tracking communicator 442, may optionally authenticate and/or identify sending system 110 and/or the sending user. For example, authentication may be achieved by checking that sending system 110 provides the correct password, user credentials, etc. In some cases of this example, authentication may be automatic, for instance by way of a remembered password or any other authentication item. In other cases of this example, authentication is performed additionally or alternatively through input by the sending user, for instance a password or other authentication item. In other embodiments, authentication is not performed. For example authentication may in some cases not be required if tracking system 140 is in the same domain as sending system 110.

In the illustrated embodiments in stage 503, it is determined by tracking system, for example by tracking communicator 442, whether or not tracking system 140 is to forward the sent message to one or more receiving systems corresponding to one or more intended receiving users. In some cases sending system 110 may be sending the message via tracking system 140 and therefore the message needs to be forwarded. In other cases, sending system 110 may not be sending the message via tracking system 140 and therefore the message does not need to be forwarded. In some embodiments all messages sent by sending system 110 are sent via tracking system 140 or all messages sent by sending system 110 are not sent via tracking system 140 and therefore the determination is the same for all messages. In some other embodiments, where tracking system 140 may become aware of different messages differently, tracking system 140 may determine if a particular message is to be forwarded based on an indication provided by sending system 110. Depending on the embodiment, the indication may be explicit or may be implicit. For example in embodiments with an implicit indication, an implicit indication may be provided by the quantity and/or contents of data sent or made accessible to tracking system 140.

If the determination is that there is a message to be forwarded (yes to stage 503), then in the illustrated embodiments method 500 continues to stage 504. If the determination is that there is no message is to be forwarded, then in the illustrated embodiments method 500 skips to stage 518.

In the illustrated embodiments, in optional stage 504 it is determined by tracking system 140, for example by tracking system incorporator 447, whether or not the tracking system contact data should be added or modified. In other embodiments, where the addition of tracking system contact data, if any, would have been correctly performed by sending system 140, or where the addition/modification is not necessary (for example because receiving system 120 would know where to send the receipt notification even if no contact data was added to the message, or even if incorrect contact data was added to the message, as will be explained in more detail below) stages 504 and 506 may be omitted.

If the determination is that tracking system contact data should be added or modified (yes to stage 504), then in the illustrated embodiments in stage 506, contact data for tracking system 140 is added or modified by tracking system 140, for instance by tracking system incorporator 447. For example, if no tracking system contact data had been added by sending system 110 to the message, tracking system contact data may be generated by tracking system 140 and added to the message. As another example, if tracking system contact data had been added by sending system 110 to the message, tracking system contact data that is generated by tracking system 140 may replace the existing contact data in the message or may be added in addition to the existing contact data. Continuing with the example, in some cases if the tracking system contact data added by sending system 110 was incorrect, tracking system 110 may replace the incorrect contact data with correct tracking system contact data.

In some embodiments in stage 506, the generated tracking system contact data is included in one of the fields of the message which would typically, although not necessarily, be presented to a receiving user in a summary inbox list. For example, assuming that an inbox summary list includes message receiver field(s), a “From” field and/or equivalent, a “Subject” field and/or equivalent, and/or a “Date/Time” field and/or equivalent, the contact data may be located in one or more of the included receiver field(s), “From” field and/or equivalent, “Subject” field and/or equivalent, and/or “Date/Time Sent” field and/or equivalent. In these embodiments, this contact data is not necessarily presented to the receiving user, because receiving system 120 may in some cases conceal this contact data as will be explained in more detail below. In other embodiments, the contact data is not necessarily included in any particular part of the message.

Depending on the embodiment, the added/modified tracking system contact data may include any suitable information which directly or indirectly allows for contacting tracking system 140. For example, in some embodiments, the tracking system contact data includes direct contact information which can be used to contact tracking system 140, for instance a URL. In another example, additionally or alternatively, tracking system contact data includes (indirect) contact information (such as an identifier of tracking system 140) which allows receiving system 120 to look up direct tracking system contact information such as a URL, for instance in a look up table accessible by receiving system 120, as will be described in more detail further below.

If instead it is determined that tracking information should not be added or modified (no to stage 504), then in the illustrated embodiments stage 506 is omitted. For example in some embodiments it may be decided not to add or modify tracking system contact data for a particular message for instance because the addition of tracking system contact data, if any, would have been correctly performed by sending system 140, or because the addition/modification is not necessary (for example because receiving system 120 for the particular message would know where to send the receipt notification even if no contact data was added to the message, or even if incorrect contact data was added to the message, as will be explained in more detail below).

In the illustrated embodiments in optional stage 508, it is determined by tracking system 110, for example by tracking system incorporator 447, whether or not message identification should be improved. In other embodiments, where all message identification improvement would always have been performed by sending system 110, or where no message identification improvement is ever performed by sending system 110 or tracking system 140, stages 508 and 510 may be omitted. For example, in some embodiments, no message identification improvement may be performed by sending system 110 or tracking system 140 because the data provided by the sending user and/or by message producer 214 (such as body of the message, name/contact data of sending user, name/contact data of receiving user(s), original message ID and/or subject) may be sufficient to identify the message. As another example, additionally or alternatively, no message identification improvement may be performed by sending system 110 or tracking system 140 if messages provided in stage 302 of method 300 always already have a satisfactory identifier located in the contents of the message.

If the determination is that the message identification should be improved (yes to stage 508), then in the illustrated embodiments in stage 510 a message identifier is added or modified by tracking system 140, for instance by tracking system incorporator 447. For example, a message identifier may be generated by tracking system incorporator 447 and added to the message. As another example, where the message already has an existing identifier (such as the Message-ID of an email message or an identifier which was added/modified by sending system 110 in stage 310), tracking system incorporator 447 may move or copy the existing value to a different location in the message, may modify the existing value, or may add a new identifier in addition to or instead of the existing identifier.

In some embodiments in stage 510, the added or modified identifier is located in one of the fields of the message which would typically, although not necessarily, be presented to a receiving user in a summary inbox list. For example, assuming that an inbox summary list includes message receiver field(s), a “From” field and/or equivalent, a “Subject” field and/or equivalent, and/or a “Date/Time” field and/or equivalent, the identifier may be located in one or more of the included receiver field(s), “From” field and/or equivalent, “Subject” field and/or equivalent, and/or “Date/Time” field and/or equivalent. In these embodiments, the identifier is not necessarily presented to the receiving user, because receiving system 120 may in some cases conceal the identifier as will be explained in more detail below. In other embodiments, the identifier is not necessarily included in any particular part of the message.

In some embodiments, the identifier added or modified in stage 510 is unique. In other embodiments the identifier is not necessarily unique and in some cases additional identifying information may be required to identify the message.

In the illustrated embodiments, if the determination is instead that the message identification should not be improved (no to stage 508) then stage 510 is skipped. For example the determination may be that message identification should not be improved because satisfactory message identification improvement for this message was performed by sending system 140, or because no identification improvement for this message should be performed by sending system 110 or by tracking system 140. Continuing with the example, in some embodiments no message identification improvement may be performed by sending system 110 or by tracking system 140 because the data provided by the user and/or by message producer 214 (such as body of the message, name/contact data of sending user, name/contact data of receiving user(s), original message ID and/or subject) may be sufficient to identify the message. In other embodiments of this example, additionally or alternatively, no message identification improvement may be performed by sending system 110 or tracking system 140 because the message provided in stage 302 of method 300 already has a satisfactory identifier located in the contents of the message.

In some embodiments, if the same message is to be forwarded to a plurality of intended receiving users, stage 510 is repeated for each intended receiving user so that if an identifier is to be added/modified, the addition/modification is different for each receiving user. In other embodiments, for a plurality of receiving users, stage 510 is not necessarily repeated for each receiving user since it may be sufficient to receive notification that one or less than all receiving users received the message and therefore a different identifier corresponding to each receiving user may be unnecessary, or because knowledge of all receiving users may be obtained otherwise (for example because a receipt notification includes information on the receiving user).

In some embodiments, tracking contact data added/modified in stage 506 and/or an identifier added/modified in stage 510 also serves as an indication that the message is being tracked. In some other embodiments (in addition to or instead of the added and/or modified tracking contact data and/or identifier) tracking system 140, for instance tracking system incorporator 447 may add to the message in stage 506 or 510 a separate indication that the message is being tracked. For example, in some cases where tracking contact data is not added by sending system 110 nor added/modified by tracking system 140, and an identifier is not added and/or modified by sending system 110 nor by tracking system 140, a separate indication of tracking may be added instead. In still other embodiments where tracking contact data is not added by sending system 110 nor added/modified by tracking system 140, and an identifier is not added and/or modified by sending system 110 nor by tracking system 140, a separate indication may not be provided because receiving system 120 in any event knows that all messages are tracked.

In some embodiments, prior to being forwarded in stage 512, the message may optionally be protected by tracking system 140 in addition to or instead of any protection which sending system 110 may have previously applied. Protection by tracking system 140 may include any of the following: encryption, hashing using a one way function, digitally signing and/or encoding, etc. In other embodiments, the message may not be protected.

In the illustrated embodiments in stage 512 the message is forwarded by tracking system 140, for instance by tracking communicator 442 to one or more intended receiving user(s). It is noted that the forwarded message may not necessarily be the same as the message received in stage 502, for example due to addition(s) and/or modification(s) performed by tracking system 140, for instance in stage 506 and/or 510.

In some embodiments with a plurality of intended receiving users, stage 512 may be repeated for each receiving user of a message, for instance because each copy of the message for a different receiving user has a different identifier. In some other embodiments, stage 512 may not necessarily be repeated for each receiving user of a message, for instance if there is no identifier, if there is only one identifier corresponding to all receiving users and therefore the message with the same identifier can be sent to all receiving users, or if there is a shared identifier corresponding to two or more receiving users and therefore the message with the shared identifier can be sent to the corresponding receiving users. These latter embodiments may be appropriate for example if it is only important to know that one receiving user or one of the corresponding receiving users received the message and not important to know that all receiving users or all corresponding receiving users received the message. Additionally or alternatively, these latter embodiments may be appropriate if identity of the receiving users may be obtained otherwise, for example because a receipt notification includes information on the receiving user.

In the illustrated embodiments, in stage 514 it is determined by tracking system 140, for example by tracking communicator 442, if feedback regarding the sent message should now be provided to sending system 110. If it is determined that feedback should be provided (yes to stage 514), then in the illustrated embodiments in stage 516 feedback is sent by tracking system 140, for instance by tracking communicator 442, to sending system 110. For example, in some cases where the message was sent via tracking system 140, feedback may be sent to indicate that tracking system 140 forwarded the message to receiving system 120. As another example, additionally or alternatively feedback may relate to additions and/or modifications to the message made by tracking system 140 in stage 506 and/or 510. If no feedback is to be sent at this point (no to stage 514), then in the illustrated embodiments stage 516 is skipped.

In the illustrated embodiments, in stage 518 access to data on the sent message is enabled by tracking system 140, for instance by accessor 444. For example, tracking system 140 may enable access by saving in tracking memory 445 some or all of the data that was made accessible to tracking system 140 in stage 502 and/or some or all of any additions/modifications performed in stage 506 and/or 510. As another example, additionally or alternatively, tracking system 140 may enable access by enabling the ability to regenerate some or all of the data that was made accessible in stage 502 and/or some or all of any additions/modifications performed in stage 506 and/or 510. In some embodiments of these examples, the stored data and/or data which can be regenerated may include all of the data in the message that will be received by receiving system 120 or only some of the data in the message that will be received by receiving system 120 (for example data in any of “from” field and/or equivalent, included receivers field(s), identifier, “subject” field and/or equivalent, date/time field and/or equivalent, body of the message, etc).

In some embodiments, the data whose access is enabled in stage 518 at least allows identification of the message in order to update receipt notification, for example as described below with reference to method 800. In some embodiments, additionally or alternatively the data whose access is enabled in stage 518 at least allows one or more follow-up actions to be performed, for example as described below with reference to method 900.

In some embodiments, stage 518 may be partly or fully performed after stage 502, for some or all of the data made accessible in stage 502.

In some embodiments, stage 518 includes setting a timer in order to determine whether or not a predetermined time will elapse without receiving a receipt notification which is identified as corresponding to the message (see below method 800). In some of these embodiments, if the predetermined time elapses without receiving the corresponding receipt notification, tracking system 140 may cause a duplicate message to be sent, for instance by providing feedback to sending system 110 to send a duplicate message, or by forwarding a duplicate message. In other embodiments no timer is set.

In the illustrated embodiments, method 500 ends after stage 518.

FIG. 6 is a block diagram of receiving system 120, according to some embodiments of the invention. In the illustrated embodiments, receiving system 120 includes a receiving user input/output 622 configured to receive data from a receiving user associated with receiving system 120 and/or present data to a receiving user associated with receiving system 120, a tracking information determiner 624 configured to determine tracking information relating to a received message, a notification composer 626 configured to compose a receipt notification, and a receiving communicator 628 configured to communicate via channel 130. Optionally, receiving system 120 may also include a receiving request handler 625 configured to handle requests and/or a receiving memory 627 configured to store data. Receiving system 120 includes at least some hardware and in various embodiments, each of receiving user input/output 622, tracking information determiner 624, notification composer 626, receiving communicator 628, receiving memory 627 and/or receiving request handler 625 may be made up of any combination of hardware, software and/or firmware capable of performing the operations as defined and explained herein. Examples of receiving user input/output 622 include keyboard, mouse, keypad, touch-screen display, microphone, speaker, non-touch-screen display, and/or printer, etc. In some embodiments any of the modules in receiving system 120 may be included in any of the following: a web browser; a mail client; an instant messaging client; a peer-to-peer application, a user interface; an SMS application; a messaging application, any other type of Internet client; a plug-in, an add-on, a toolbar or an applet for a browser or a mail client or an instant messaging client; a standalone client; any other suitable element servicing one user device; a gateway; a proxy server; any other type of server; and/or any other suitable element servicing multiple user devices, etc.

In some embodiments, receiving system 120 may comprise fewer, more, and/or different modules than those shown in FIG. 6. In some embodiments, the functionality of receiving system 120 described herein may be divided differently among the modules of FIG. 6. In some embodiments, the functionality of receiving system 120 described herein may be divided into fewer, more and/or different modules than shown in FIG. 6 and/or receiving system 120 may include additional, less and/or different functionality than described herein. For example, receiving system 120 may include other module(s) for receiving messages in addition to or instead of one or more of the modules illustrated in FIG. 6. As another example, additionally or alternatively modules 624 and 626 may be combined together. Depending on the embodiment modules in receiving system 120 may be concentrated in one unit or separated among two or more units. For example, receiving system 120 may include an embedded display or a detached display when receiving user input/output 622 includes a display. As another example, additionally or alternatively, in some cases, receiving system 120 may be divided into two sub-systems, with a first subsystem including receiving user input 622 and optionally a communicator to communicate with the second subsystem and the second subsystem including tracking information determiner 624, notification composer 626, receiving communicator 628, and optionally receiving memory 627 and/or receiving request handler 625. In these embodiments, the two subsystems may or may not be located at the same location. As another example, additionally or alternatively, in some cases two or more of the modules in receiving system 120 may be divided between a first element such as a web browser, an email client, an instant messaging client, a peer-to-peer application, a user interface, a messaging application, an SMS application, any other type of Internet client, any other suitable element servicing one user device, a gateway, a proxy server, any other type of server and/or any other suitable element servicing multiple user devices, and a second element such as an applet, toolbar, plug-in or add-on to the first element, a standalone element associated with one user device, a gateway, a proxy server, any other type of server and/or any other standalone element servicing multiple user devices. In these embodiments, the two elements may or may not be located at the same location.

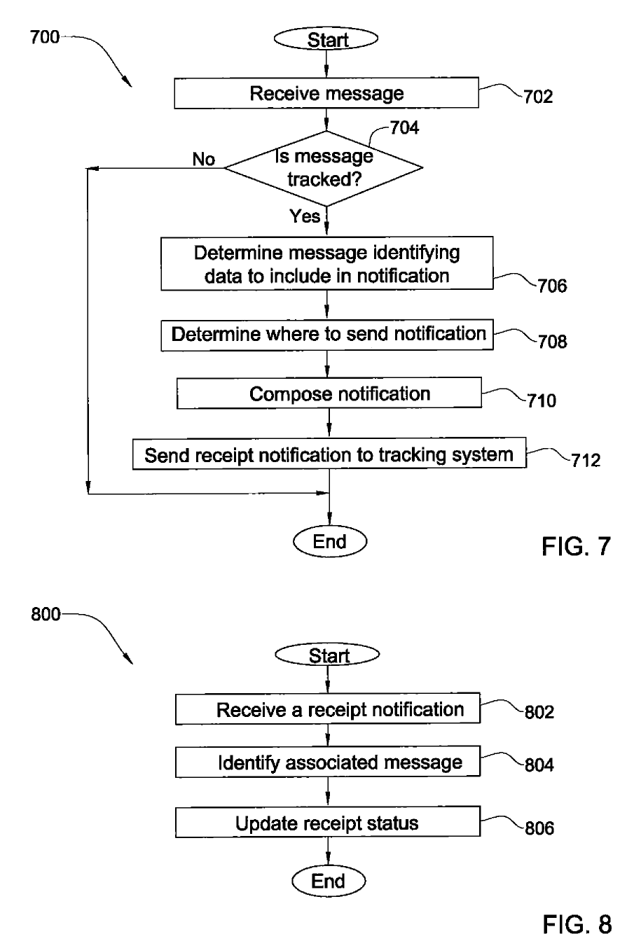

FIG. 7 is a flowchart of a method 700 of receiving messages, according to some embodiments of the invention. Method 700 is performed in some embodiments by receiving system 120. In some cases, method 700 may include fewer, more and/or different stages than illustrated in FIG. 7, the stages may be executed in a different order than shown in FIG. 7, and/or stages that are illustrated as being executed sequentially may be executed in parallel.

In the illustrated embodiments in stage 702, receiving system 120, for example receiving communicator 628, receives a message.

In the illustrated embodiments in stage 704, receiving system 120, for instance tracking information determiner 624, determines whether or not the received message is being tracked. For example, in some cases, the presence of an identifier, the presence of an identifier at a predefined location, the presence of tracking system contact data, and/or any other indication in the message may allow tracking information determiner 624 to determine that the message is being tracked. Similarly in this example, in some cases, the absence of an identifier (or the absence of an identifier at a predefined location), the absence of tracking system contact data and the absence of any other indication may allow tracking information determiner 624 to determine that the message is not being tracked.

In some embodiments, receiving system 120 may be able to make a determination of whether or not the message is being tracked based on data in one or more fields which would typically, although not necessarily, be presented to a receiving user in an inbox summary list. For example, in some of these embodiments, assuming that an inbox summary list includes message receiver field(s), a “From” field and/or equivalent, a “Subject” field and/or equivalent, and/or a “Date/Time” field and/or equivalent, then an identifier, tracking system contact data and/or another indication of tracking, if present, will be present in one or more of those fields. In other embodiments, an identifier, tracking system contact data and/or another indication, if present, may be located anywhere in the message.

In some embodiments, any identifier, tracking system contact data and/or other indication of tracking which is/are located in a part of the message to be presented to the receiving user, is/are removed from the message or otherwise concealed by receiving system 120, for instance by tracking information determiner 624, prior to presentation to the receiving user. In these embodiments any identifier, tracking system contact data and/or other indication of tracking will therefore not be presented to the receiving user. In other embodiments an identifier, tracking system contact data and/or another indication of tracking may possibly be presented to the receiving user.

In some cases, there may be advantages to embodiments where receiving system 120 may be able to make a determination of whether or not the message is being tracked, find any identifier, tracking system contact data, and/or other tracking indication based on data in one or more fields which would typically, although not necessarily, be presented to a receiving user in an inbox summary list, rather than based on data elsewhere in the message. For example, it may be faster for receiving system to make a determination of whether or not the message is tracked and to find any identifier, tracking system contact data and/or other tracking information than if the data were located in a different part of the message.

In some embodiments, stage 704 optionally also includes checking whether or not the received message is a duplicate of a message previously received. For example, in some of these embodiments, if tracking system 140 does not receive a receipt notification for a message within a predetermined time, the message may be sent by sending system 110 and/or forwarded by tracking system 140 a second time. In some cases of these embodiments, both the original message and the second message may eventually be received (in any order) by receiving system 120. In embodiments where the received message is a duplicate of a message previously received, the message may in some cases be identified as a duplicate, for example based on an identifier and/or other identifying information in the message. Continuing with this example, other identifying information may include for instance data in the “From” field and/or equivalent such as sending user name and/or contact information, the user name and/or contact information of the receiving user corresponding to receiving system 120, the body of the message, data in the “date/time” field and/or equivalent such as date/time sent and/or received, data in the “subject” field and/or equivalent, all data which was comprised in the message, etc. Depending on the embodiment where a duplicate message has been identified, the remainder of method 700 may continue for the duplicate message resulting in a receipt notification sent for the duplicate message, or method 700 may end without sending a notification for the duplicate message. Depending on the embodiment where a duplicate message has been identified, the duplicate message may or may not be deleted or otherwise concealed by receiving system 120. In embodiments where the duplicate message is deleted the deletion may occur at this stage or at a later point in time. For instance, the duplicate message can in some cases be deleted from the message store or user interface. Depending on the embodiment where a duplicate message has been identified, receiving system 120 may or may not inform tracking system 140 and/or sending system 110 of the duplication. For example, in some cases, indication of the duplication may be included in a receipt notification if sent.

In the illustrated embodiments, if the message is being tracked (yes to stage 704), then method 700 continues with stage 706. If instead, the message is not being tracked (no to stage 704) then in the illustrated embodiments method 700 ends and the received message is processed conventionally.

In the illustrated embodiments in stage 706, receiving system 120, for instance tracking information determiner 624, determines message identifying information to include in a receipt notification. For example, in some embodiments, if the message includes an identifier which tracking system 140 can use in identifying the corresponding message, the identifier is included in the receipt notification. Additionally or alternatively, other identifying information may be included, for instance data in the “From” field and/or equivalent such as sending user name and/or contact information, the user name and/or contact information of the receiving user corresponding to receiving system 120, the body of the message, data in the “date/time” field and/or equivalent such as date/time sent and/or received, data in the “subject” field and/or equivalent, all data which was comprised in the message, etc.

In the illustrated embodiments in stage 708, receiving system 120, for example tracking information determiner 624, determines where to send a receipt notification so that receipt status can be updated. For example, in some embodiments, the message may include tracking system contact data which was added/modified for example in stage 306 and/or 506. The added/modified tracking system contact data may include any suitable information which directly or indirectly allows for contacting tracking system 140. Continuing with the example in some embodiments, the tracking system contact data includes contact information which can be used directly, for instance a URL. Additionally or alternatively in some embodiments of the example, tracking system contact data includes (indirect) contact information which allows receiving system 120 to look up direct tracking system contact data such as a URL. Continuing with the latter embodiments, in some cases, the indirect contact data may be an identifier of tracking system 140 which can be used by receiving system 120 to look up the corresponding direct contact information (such as a URL) in a look up table which associates identifiers of tracking system(s) 140 with corresponding direct contact data. For instance, the look up table may be stored in memory 215 or in a location in network 100 accessible to receiving system 120.

In some other embodiments, additionally or alternatively, receiving system 120 can determine where to send the receipt notification even if tracking system contact data was not included in the message or the incorrect tracking system contact data was included in the message.

In some of these other embodiments, receiving system 120 determines where to send the receipt notification based on contact information of the sending user. For instance, assume that sending user(s) from one or more particular domains are associated with a specific tracking system 140. In this instance, using (indirectly) the contact information of the sending user (e.g. domain of the email address etc), receiving system 120 can look up in a table the direct contact data (such as URL) of the corresponding tracking system. Continuing with this instance, in some cases the look up table may be stored in memory 215 or in a location in network 100 accessible to receiving system 120.

In some of these other embodiments, where there is only one central tracking system 140, receiving system 120 knows to send the receipt notification to the central tracking system 140.

In some of these other embodiments the determination of where to send is based on predetermined policy. For example, the predetermined policy may be to send a receipt notification to all tracking systems 140 in network 100 simultaneously. As another example, the predetermined policy may be to send a receipt notification to tracking systems 140 in network 100 one by one until the correct tracking system 140 is reached for updating receipt status. As another example, the predetermined policy may be to send a receipt notification to one tracking system 140 in network 100, for instance an in-house tracking system, which then forwards the notification to the correct tracking system 140, or forwards the notification to all other tracking systems 140 simultaneously or one by one until the correct tracking system 140 is reached. In these examples, tracking systems 140 which receive irrelevant notifications may report to receiving system 120 that the notification is irrelevant, may discard the notification and/or may perform any other appropriate response.

In some cases, tracking system contact data which was included in the message may be ignored in favor of other embodiments for determining where to send the notification. For example, instead of using the included tracking system contact data, receiving system 120 may decide to send to the tracking system determined by the contact information of the sending user, to a central tracking system, to all tracking systems, or to one tracking system 140 for forwarding.

It is noted that based on the description above of some embodiments, there may be various embodiments where data included in the message is used to determine where to send the notification. For example, in some of these embodiments, tracking system contact data can be used directly or indirectly as described above. In another example, in some of these embodiments, additionally or alternatively other data in the message such as contact information of the sending user may be used indirectly to determine where to send the notification.

In the illustrated embodiments in stage 710, the receipt notification is composed by receiving system 120, for example by notification composer 626. In some embodiments the receipt notification at least includes identifying information which was determined in stage 706 should be included in the notification. In some embodiments, the receipt notification may additionally or alternatively include other information. For instance, in some of these embodiments, the receipt notification may include an indication of one or more characteristic(s) of receiving system 120. Examples of characteristic(s) which may be included in the receipt notification include any of the following: type of user device, type of platform, type of operating system, browser version, Internet Protocol address, unique device identifier, etc. For instance, if receiving system 120 includes a user device, the indication of characteristic(s) of receiving system may include an indication of the type of user device such as personal computer, cell phone, smartphone, laptop, tablet computer, etc. Additionally or alternatively, for instance, types of platform may include PC, Mobile, etc. The indication of characteristic(s) of receiving system 120 may in some cases of these embodiments be advantageous, particularly if it is not obvious which receiving system received a message. It may not be obvious which receiving system 120 received the message because in some cases different receiving systems may be used to receive the same type of messages destined for different intended receiving users, and/or because in some cases different receiving systems may be used to receive the same type of messages by the same intended receiving user. For example, in some embodiments, any of various types of user devices such as smartphone, laptop, personal computer, tablet computer, etc may be used in receiving email type messages.

Additionally or alternatively, as another example of other information, in some embodiments where the receipt notification is being composed for a duplicate message, the receipt notification may include an indication that the message was a duplicate of a message previously received (and therefore the receipt notification is a duplicate).

Additionally or alternatively, as another example of other information, the receipt notification may include information regarding when the message was received such as date and/or time of receipt.

Additionally or alternatively, as another example of other information, the receipt notification may include other data collected by receiving system 120.

In the illustrated embodiments in stage 712 the receipt notification composed in stage 710 is sent by receiving system 120, for example by notification composer 626 to tracking system(s) 140 as determined in stage 708.

In some embodiments prior to sending the receipt notification, tracking system 140 may optionally authenticate and/or identify receiving system 120 and/or the receiving user. For example, authentication may be achieved by receiving system 120, providing the correct password, user credentials, etc. In some cases of this example, authentication may be automatic, for instance by way of a remembered password or any other authentication item. In another example, authentication is performed additionally or alternatively through input by the receiving user to receiving system 120 (e.g. via receiving user input/output 622), for instance a password or other authentication item. In other embodiments, authentication is not performed, for example authentication may in some cases not be required if tracking system 140 is in the same domain as receiving system 120.

FIG. 8 is a flowchart of a method 800 of updating receipt statuses of messages, according to some embodiments of the invention. Method 800 is performed in some embodiments by tracking system 140. In some cases, method 800 may include fewer, more and/or different stages than illustrated in FIG. 8, the stages may be executed in a different order than shown in FIG. 8, and/or stages that are illustrated as being executed sequentially may be executed in parallel.

In the illustrated embodiments in stage 802, a notification of receipt of a message is received by tracking system 140, for example by tracking communicator 442, from receiving system 120.

In some embodiments, prior to stage 802, tracking system 140, for instance tracking communicator 442, may optionally authenticate and/or identify receiving system 120 and/or the receiving user. For example, authentication may be achieved by checking that receiving system 120 provides the correct password, user credentials, etc. In some cases of this example, authentication may be automatic, for instance by way of a remembered password or any other authentication item. In other embodiments, authentication is not performed, for example authentication may in some cases not be required if tracking system 140 is in the same domain as receiving system 120.

In the illustrated embodiments in stage 804, tracking system 140, for instance accessor 444, identifies the message associated with the received notification. In some embodiments, the notification includes an identifier (for example as existing in the produced message and/or added and/or modified in stage 310 and/or 510) and the identifier is sufficient for tracking system 140 to identify with sufficient probability the message associated with the notification. In some other embodiments, the notification includes, in addition to or instead of an identifier, other identifying data which enables identification of the associated message with sufficient probability. For example, in some of the latter embodiments, the identifier may not be unique and therefore in order to enable identification with sufficient probability, other identifying data may be required. As another example, in some of the latter embodiments, other identifying data may be used instead of the identifier. The other identifying data is not limited by embodiments of the invention but for the sake of further illustration to the reader some examples include data in the “From” field and/or equivalent such as sending user name and/or contact information, the user name and/or contact information of the receiving user corresponding to receiving system 120, the body of the message, data in the “date/time” field and/or equivalent such as date/time sent and/or received, data in the “subject” field and/or equivalent, all data which was comprised in the message, etc. Embodiments of the invention do not limit the level of sufficient probability and in some cases the required level may be 100% but in other cases the level may be lower.

In the illustrated embodiments in stage 806, tracking system, for instance accessor 444, updates the receipt status of the associated message to indicate that the message has been received. In some embodiments, updating the receipt status can include, for example, storing in tracking memory 445 an indication that the message was received (and optionally when the message was received) and/or enabling the ability to generate an indication that the message was received (and optionally when the message was received).

In some embodiments, the received notification may include an indication of characteristic(s) of receiving system 120 which received the message and reported the notification, and possibly additional data collected by receiving system 120. In some of these embodiments, updating stage 806 includes enabling later access to the indication of characteristic(s) of receiving system 120 and possibly the additional collected data. In some cases, enabling later access to an indication of characteristic(s) of receiving system 120 and possibly the additional collected data can include, for example, storing in tracking memory 445 an indication of characteristic(s) of receiving system 120 and possibly the additional collected data, and/or enabling the ability to generate an indication of characteristic(s) of receiving system 120 and possibly the additional collected data.

In some embodiments, the receipt notification may be recognized as a duplicate of a notification previously received, for instance because the notification includes an indication that the notification is a duplicate or for instance after identification of the associated message. Depending on the embodiment, stage 806 may be omitted for a duplicate notification, or stage 806 may be performed for a duplicate notification. In embodiments where stage 806 is performed for a duplicate notification, the updating may replace the updating for the previously received notification or may supplement the updating for the previously received notification.

In the illustrated embodiments, method 800 ends after stage 806 for that receipt notification.

In some cases, method 800 is repeated for the same message with a plurality of receiving users, as different receiving systems associated with the different receiving users send notifications. It is noted that in some embodiments with a plurality of receiving users, notifications from different receiving users for the same message may be distinguishable (for example since the notifications refer to different identifiers, and/or refer to different receiving users, etc) and may therefore result in separate updating of the receipt status (including in some cases characteristic(s) of receiving system and possibly additional collected data). In other embodiments with a plurality of receiving users, notifications from different receiving users for the same message may not be distinguishable (for example since the notifications refer to the same identifier, same subject, same time/date, same message body, and/or same sending user, etc). In these embodiments the receipt status may be updated only for the first notification, or the status may include an indication of the number of notifications received but not the identity of the receiving users. In these embodiments, characteristic(s) of receiving system and additional collected data, if updated, may mention only characteristic(s) and possibly additional collected data indicated in the first notification, or characteristic(s) and possibly additional collected data indicated by all notifications for the message.

As mentioned above, in some embodiments, tracking system 140, for example accessor 444, may have set a timer in stage 518 of method 500 in order to determine whether or not a corresponding receipt notification for a message is received and identified within a predetermined time (in stage 802/804). In some of these embodiments, if the predetermined time elapses without arrival of the corresponding receipt notification, then tracking system 140 may cause a duplicate message to be sent, for instance by sending feedback to sending system 110 to send a duplicate message, or by forwarding a duplicate message. In some cases where a duplicate message is sent, the duplicate message may be protected. Protection may include any of the following: encryption, hashing using a one way function, digitally signing and/or encoding, etc. In other cases where a duplicate message is resent, the message may not be protected. In other embodiments, no timer is set.

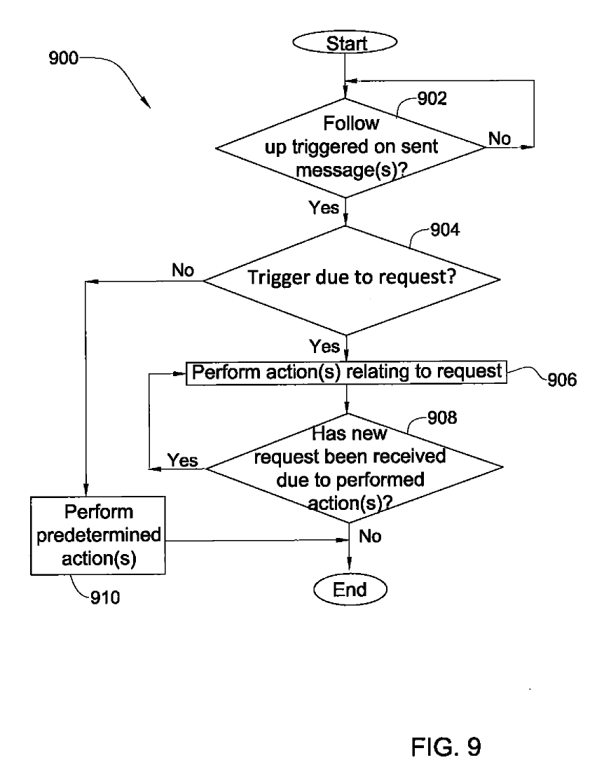

FIG. 9 is a flowchart of a method 900 of performing follow-up actions relating to sent messages, according to some embodiments of the invention. Method 900 is performed in some embodiments by tracking system 140. In some cases, method 900 may include fewer, more and/or different stages than illustrated in FIG. 9, the stages may be executed in a different order than shown in FIG. 9, and/or stages that are illustrated as being executed sequentially may be executed in parallel.

In the illustrated embodiments in stage 902 it is determined by tracking system 140, for instance by follow up action performer 446, whether or not follow up relating to sent message(s) has been triggered. In various embodiments, follow up may be triggered by any of the following inter-alia: a received request and/or automatically. For example, the request may be received from a system associated with an interested party or from any other system. In this example, the interested party may be for instance the sending user of one or more of the sent message(s) for which follow up is being triggered and who is associated with a sending system such as system 110. Additionally or alternatively the interested party may be for instance the receiving user (or intended receiving user) of one or more of the sent message(s) for which follow up is being triggered and who is associated with a receiving system such as system 120. The request may have been received for example by tracking communicator 442 and passed to follow up action performer 446. In embodiments with automatic triggering, the conditions for automatic triggering are not limited by embodiments of the invention but for the sake of further illustration to the reader, some examples are now provided. In one example automatic triggering may be periodic. In another example, additionally or alternatively, automatic triggering may be based on volume considerations such as volume of sent messages since last triggering, volume of receipt notifications since last triggering, volume of sent messages for which no receipt notification was received since last triggering, etc.

If no follow up has been triggered (no to stage 902), method 900 waits until follow up is triggered. If instead follow up had been triggered (yes to stage 902), method 900 continues to stage 904.

In the illustrated embodiments, in stage 904, it is determined by tracking system 140, for instance by follow up action performer 446, whether or not the trigger from stage 902 was due to a request.

If the trigger was due to a request (yes to stage 904) then in the illustrated embodiments method 900 continues with stage 906. If the trigger was not due to a request (no to stage 904), then in the illustrated embodiments method 900 continues with stage 910.

In the illustrated embodiments in stage 906, tracking system 140, for example follow up action performer 446, performs one or more follow up actions relating to the received request. Embodiments of the invention do not limit what is included in the request, but for the sake of illustration some examples will now be provided. In one example, the desired follow up action(s) are indicated in the request whereas in another example, one or more desired follow up action(s) are not indicated. Additionally or alternatively, in one example, the message(s) relating to the request are specified, for instance by identifier and/or other identifying data, whereas in another example, criteria to determine the related messages are specified, and in a third example, neither the related message(s) nor criteria are specified in the request. Additionally or alternatively in one example where an action includes reporting, the type(s) of data to be listed in the report is specified in the request whereas in another example, the type(s) of data are not specified in the request. Additionally or alternatively in one example where an action includes resending in a different manner, the different manner is specified in the request whereas in another example, the different manner is not specified in the request. In some cases where the request does not specify follow up action(s), message(s), criteria, different manner, and/or data, tracking system 140 may figure out what is not specified.

In the illustrated embodiments, in stage 908 it is determined by tracking system 140, for example by follow up action performer 446. if a new request has been received due to action(s) performed in stage 906. If a new request has been received (yes to stage 908) then in the illustrated embodiments method 900 iterates to stage 906 to perform one or more actions based on the newly received request. If no new request has been received (no to stage 908), then in the illustrated embodiments method 900 ends.

If method 900 instead proceeded to stage 910, then in the illustrated embodiments in stage 910 one or more predetermined follow up actions are performed by tracking system 140, for example by follow up action performer 446. In the illustrated embodiments method 900 then ends.

In some embodiments of stage 906 and/or 910, follow up action performer 446 performs one or more follow up action(s) which may include any appropriate operations. In some of these embodiments, it is possible that one or more of the operations is achieved by utilizing other module(s) of tracking system 140. Embodiments of the invention do not limit the operations but for the sake of further illustration to the reader, some examples are now provided. In one example, an operation may include utilizing accessor 444 to check tracking memory 445 for data relating to receipt or non-receipt (such as if a receipt notification was received, time of message receipt, characteristic(s) of receiving system and/or additional data collected by receiving system, etc) for message(s) relating to follow-up action(s). In another example, additionally or alternatively, an operation may include generating data relating to receipt or non-receipt (such as if a receipt notification was received, time of message receipt, characteristic(s) of receiving system and/or additional data collected by receiving system, etc) for message(s) relating to follow-up action(s). In another example, additionally or alternatively an operation may include calculating aggregate statistics (such as totals) for reports. In another example, additionally or alternatively, an operation may include modifying message data. In another example, additionally or alternatively, an operation may include utilizing accessor 444 to retrieve from memory message data. In another example, additionally or alternatively an operation may include generating message data. In another example, additionally or alternatively an operation may include passing messages to tracking communicator 442 for sending. In another example, additionally or alternatively an operation may include passing reports to tracking communicator 442 for sending. In another example, additionally or alternatively an operation may include passing confirmations to tracking communicator 442 for sending, etc. In another example, additionally or alternatively an operation may include protecting data. The data generated, modified, protected and/or retrieved for a message may comprise all of the data or only some of the data relating to the message.

Embodiments of the invention do not limit the possible action(s) performed in stage 906 and/or 910 but for the sake of further illustration to the reader, some examples will now be provided.

In some embodiments, the action(s) performed in stage 906 and/or 910 include resending any messages for which receipt notifications were not received. In some of these embodiments a message for which a receipt notification was not received is resent in the same manner as previously sent, whereas in other of these embodiments such a message is resent in a different manner. In some embodiments where a message is resent in a different manner, the different manner may include resending the message via a different communication channel. For example the different channel used for resending the message may be a direct connection which may be secure and/or authenticated from tracking system 140 to receiving system 120. As another example the different channel may include a different message format. Continuing with the example, if the original message was sent as an email, the resent message may be sent as an SMS or instant message. Additionally or alternatively, in some embodiments where the message is resent in a different manner, the different manner may include resending the message using different contact information for the intended receiving user than used when originally sending the message, for example to an alternate mobile phone number, alternate email address, etc. In these embodiments, depending on the embodiment, tracking system 140, for instance tracking communicator 442, may receive the alternate contact information for intended receiving user(s) in the request, or the various contact options per intended receiving user including the alternate contact information may have been previously stored in tracking memory 445 and may therefore be accessible.

In some cases where a message is resent in a different manner than previously sent, the message may be modified prior to resending in order to better accommodate the different manner. In other cases, the message may not be modified.

In some cases where a message is resent, the message may be protected. Protection may include any of the following: encryption, hashing using a one way function, digitally signing and/or encoding, etc. In other cases where the message is resent, the message may not be protected.

In some cases where a message is resent, the message includes an indication that the message is a resent message. In other cases the message includes such an indication if the message is being resent in response to a request so that the resent message can be recognized as a reply to the request. In still other cases, the resent message does not include an indication that the message is a resent message.

In some embodiments, the action(s) performed additionally or alternatively includes reporting of message(s) for which receipt notifications were not received. Depending on the embodiments, the contents of the report may vary. For example, the report may include a list of the message(s) for which receipt notifications were not received, the total number of messages for which receipt notifications were not received, and/or if the message was sent to a plurality of intended receiving users for which of the intended receiving users receipt notifications were not received, etc. Additionally or alternatively, as another example the report may include a way to obtain or read the non-received messages data, for instance, by means of a URL. In some case of this example access to the messages data, for instance by means of the URL, may require authentication.

In some embodiments, the action(s) performed additionally or alternatively includes reporting of message(s) for which receipt notifications were received. Depending on the embodiments, the contents of the report may vary. For example, the report may include a list of the message(s) for which receipt notifications were received and optionally the time of receipt of each message, the total number of messages for which receipt notifications were received, and/or if the message was sent to a plurality of intended receiving users for which receiving users receipt notifications were received, etc.

In some embodiments, the action(s) performed additionally or alternatively includes reporting resent messages. Depending on the embodiments, the contents of the report may vary. For example, the report may include a list of the resent message(s), the number of message(s) resent, whether or not a resent message was sent in the same or different manner as originally sent, the alternate contact data used to resend a message if the message was resent using alternate contact data, the alternate communication channel used to resend a message if the message was resent using an alternate communication channel, and/or the total number of resent messages, etc.

In some embodiments, the action(s) performed additionally or alternatively includes reporting a confirmation that a request has been honored. Depending on the embodiments, the contents of the report may vary. For instance, assuming the request related to resending messages, the report may confirm that messages were resent, that messages were resent in the same manner, and/or that messages were resent in a different manner, etc. As another example assuming the request related to providing a report, the confirmation may state that a report was sent.

In some embodiments, the action(s) performed additionally or alternatively includes reporting characteristic(s) of receiving systems used to receive messages. Depending on the embodiments, the contents of the report may vary. For example, the report may include characteristic(s) of receiving system for each of one or more received messages, may include additional collected data, and/or may include for each tracked characteristic the total number of receiving systems used to receive messages having that characteristic. In some cases, such a report may be useful for example for sending system 110 in order to send in the future a message in a form which suits characteristic(s) of the receiving system typically although not necessarily used by a particular intended receiving user of the message, or in general to send messages in a form which suits characteristic(s) of receiving systems typically although not necessarily used by a substantial number of possible receiving users.

In some embodiments, the message(s) listed in any report produced as a follow up action may depend on the request received (in the case that a request was received), whereas in other embodiments the message(s) listed in the report may additionally or alternatively depend on predetermined conditions. The stipulations of the request and/or predetermined conditions are not limited by the invention, but for the sake of illustration some examples are now provided. For example, the request or the predetermined conditions may stipulate that any messages not included in a previous such report be included (exclusively or not necessarily exclusively) in the current report. Additionally or alternatively in another example, the request and/or the predetermined conditions may stipulate that any messages from the last stipulated time period be included (exclusively or not necessarily exclusively) in the report. Additionally or alternatively in another example, the request and/or the predetermined conditions may stipulate that only messages sent or received by an interested party are listed in the report. For instance, only messages by a particular sending user or sending system are listed in the report sent to the particular sending user or sending system, or only messages intended for a specific receiving user are listed in a report sent to the specific receiving user. Additionally or alternatively in another example, the request and/or the predetermined conditions may stipulate that the messages listed in a report may include, but not necessarily exclusively, messages relating to an interested party to whom the report is sent. Continuing with the example, the report may be sent to one or more interested parties, including for instance to a sending user of at least one of the messages listed in the report and/or including for instance to an intended receiving user of at least one of the messages listed in the report. Additionally or alternatively in another example, the request and/or the predetermined conditions may stipulate that the report may include messages unrelated to the user to whom the report is being sent. Continuing with the example, the report may be sent to sending and/or receiving user(s) which are not necessarily interested parties. Additionally or alternatively, the request and/or the predetermined conditions may stipulate that messages from a sending system which sent the request be included (exclusively or not necessarily exclusively) in the report, or that messages for an intended receiving user associated with a receiving system which sent the request be included (exclusively or not necessarily exclusively) in the report. Additionally or alternatively the request and/or the predetermined conditions may stipulate that messages sent by a particular sending user(s) or sending system(s), or messages intended for particular receiving user(s) be included (exclusively or not necessarily exclusively) in the report. In another example, additionally or alternatively, the request and/or the predetermined conditions may stipulate that messages of particular subject(s) be included (exclusively or not necessarily exclusively) in the report. Additionally or alternatively, the request and/or the predetermined conditions may stipulate that messages for which follow up action(s) were previously performed be included (exclusively or not necessarily exclusively) in the report. Additionally or alternatively, a request may stipulate that messages specified in the request or responding to criteria stated in the request be included (exclusively or not necessarily exclusively) in the report.

Depending on the embodiment, the information included for each message in a report may vary. For example in some embodiments, the information included for each message at least includes sufficient data for the receiver of the report to identify the message. Continuing with the example, in some of these embodiments the sufficient data may include for each message the identifier and/or other identifying data. As another example, additionally or alternatively, the report can include for each message: the body of the message, the identifier, data in included receivers field(s), data in the “From” field and/or equivalent, data in the “Subject” field and/or equivalent, data in the “Date/Time” field and/or equivalent, any other data and/or the entire message, etc.

Depending on the embodiment, the report may be sent by tracking system 140 in any appropriate way. For example, in some embodiments, the report may be sent by email. As another example, additionally or alternatively, the report may be sent to a user interface. As another example, additionally or alternatively, the report may be sent via the same communication channel that a request which triggered the report was received. As another example, additionally or alternatively, the report may be sent via the same communication channel used to receive and/or forward messages and/or receipt notifications relating to the report. In other embodiments, the report may be sent additionally or alternatively in a different way.

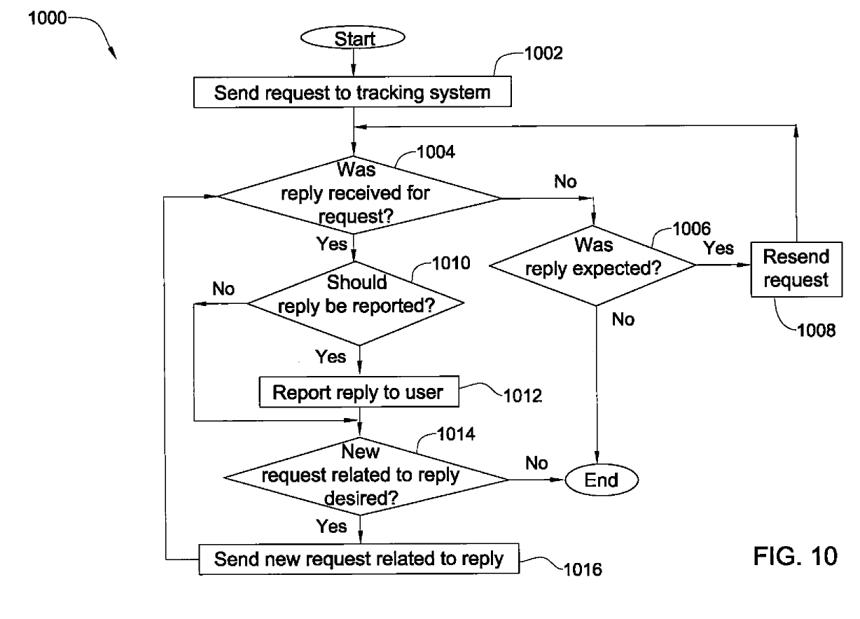

FIG. 10 is a flowchart of a method 1000 of handling requests, according to some embodiments of the invention. Method 1000 may be performed by any requesting system. For simplicity of description, it is assumed in the illustrated embodiments that the requesting system which performs method 1000 is sending system 110 and/or receiving system 120. For example sending request handler 218 or receiving request handler 625 may perform method 1000. In some cases of this example it is possible that sending request handler 218 or receiving request handler 625 utilizes other module(s) of sending system 110 or receiving system 120 respectively to perform one or more stages of method 1000. In some embodiments, the requesting sending system 110 and/or receiving system 120 which is assumed to perform method 1000 is/are associated with interested party/ies. In some cases, method 1000 may include fewer, more and/or different stages than illustrated in FIG. 10, the stages may be executed in a different order than shown in FIG. 10, and/or stages that are illustrated as being executed sequentially may be executed in parallel.

In the illustrated embodiments in stage 1002 a request relating to sent messages is sent to tracking system 140. Depending on the embodiment, the request may be initiated by the user (e.g. sending user or receiving user) or may be automatically initiated by the system performing stage 1002 (e.g. requesting sending system 110 or receiving system 120).

Embodiments of the invention do not limit the messages relating to the request, although for further illustration to the reader, some examples will now be provided. In one example, the request relates to tracked messages for which receipt notifications were not received. In another example, additionally or alternatively the request relates to tracked messages for which receipt notifications were received. In another example, additionally or alternatively, the request relates only to tracked messages relating to the system performing stage 1002 or corresponding user. Additionally or alternatively when the request is sent by a receiving system 120, the request for example may relate to tracked messages sent by a particular sending user(s) or sending system(s), or for example may relate to tracked messages sent by all sending users and sending systems. Additionally or alternatively when the request is sent by a sending system 110, the request for example may relate to tracked messages intended for particular receiving user(s) or receiving system(s), or for example may relate to tracked messages intended for all receiving users and receiving systems. In another example, additionally or alternatively, the request relates to tracked messages corresponding to a specific time period. In another example, additionally or alternatively, the request relates to tracked messages which were not the subject of any previous requests and/or for which an automatic follow up action(s) was not previously performed. In another example, additionally or alternatively, the request relates to tracked messages of particular subject(s). In another example, additionally or alternatively, the request relates only to messages for which follow up action(s) were previously performed.

In some embodiments the specific messages relating to the request may be specified in the request. For example, at least sufficient data for tracking system 140 to identify the specific messages may be specified in the request. Continuing with the example, sufficient data may include for each message the identifier and/or other identifying data. In some other embodiments, additionally or alternatively the criteria for realizing which messages relate to the request are stated in the request. In some other embodiments, additionally or alternatively, tracking system may know which messages relate to any received request or to a request such as the current request.

Embodiments of the invention do not limit the (follow up) action or actions which should be performed in response to the request but for the sake of further illustration to the reader, some examples will now be provided. In one example, a follow up action includes reporting tracked messages relating to the request (e.g. report on resent messages, report of characteristic(s) of receiving systems used to receive messages, report on messages for which receipt notifications were received, report on messages for which receipt notifications were not received, etc.) In another example, additionally or alternatively, a follow-up action includes resending of tracked messages relating to the request to the intended receiving user(s) in the same or in a different manner than previously sent. In another example, additionally or alternatively, a follow up action includes reporting a confirmation that a request has been honored.

In some embodiments, the follow up action or actions are specified in the request whereas in other embodiments one or more actions may not be specified in the request and tracking system 140 knows the action(s) to perform upon receiving any request or upon receiving a request such as the current request.

Embodiments of the invention do not limit the type(s) of data to be received in a report relating to tracked messages, but for the sake of further illustration to the reader, some examples will now be provided. For example in some embodiments, the information included for each message at least includes sufficient data for the receiver of the report to identify the message. Continuing with the example, in some of these embodiments the sufficient data may include for each message the identifier and/or other identifying data. As another example, additionally or alternatively, the report can include for each message: the body of the message, the identifier, data in included receivers field(s) data in the “From” field and/or equivalent, data in the “Subject” field and/or equivalent, data in the “Date/Time” field and/or equivalent, any other data and/or the entire message, etc.

In some embodiments, the type(s) of data are specified in the request, whereas in other embodiments one or more types may not be specified and tracking system 140 knows the type(s) of data to provide in any requested report or in a requested report such as the current requested report.

In some embodiments, prior to stage 1002, tracking system 140, may optionally authenticate the requesting system (e.g. system 110 or 120) and/or the user (e.g. sending or receiving) which is sending the request. For example, authentication may be achieved by checking that the requesting system provides the correct password, user credentials, etc. In some cases of this example, authentication may be automatic, for instance by way of a remembered password or any other authentication item. In other embodiments, authentication is not performed, for example authentication may in some cases not be required if tracking system 140 is in the same domain as the requesting system.

In the illustrated embodiments, in stage 1004, it is determined if a reply has been received to a request. Depending on the embodiment, the reply can be in any appropriate form. For example, in various embodiments a reply can include a report, and/or any resent messages sent to the requesting system (assuming that resent messages can be recognized as such) etc. It is noted that if the request resulted in message(s) being resent by tracking system 140, the receiving system(s) which received the resent message(s) may handle the receipt as in method 700 described above. In embodiments where resent messages are sent to the requesting system and recognized as a reply, method 700 may possibly be executed in parallel with the remainder of method 1000.

If a reply was not received (no to stage 1004), then in the illustrated embodiments in stage 1006 it is determined if a reply was expected. In some embodiments a reply may not be expected because it is taken for granted that tracking system 140 performed the request. In some other embodiments whether or not a reply is expected depends on the request. In still some other embodiments, a reply is expected. If a reply was expected (yes to stage 1006) then in the illustrated embodiments the request is resent in stage 1008. Otherwise, if no reply was expected (no to stage 1006), then method 1000 ends.

If on the other hand a reply was received to the request (yes to stage 1004), then in the illustrated embodiments in stage 1010 it is determined if the reply should be reported to the user associated with the requesting system 110 or 120. For example, in some embodiments where the user initiated the request, or because of other considerations, the reply is to be reported to the user.

If the reply should be reported to the user (yes to stage 1010), then in the illustrated embodiments in stage 1012 the reply is reported to the associated user, for instance via the user input/output of the requesting system (e.g. user input/output 212 or 622) or via a message sent to the associated user (e.g. via email). For example, if the reply includes a list of messages, for instance messages for which receipt notifications were not received and optionally a way to obtain or read the non-received messages data, or a list of characteristic(s) of receiving systems and optionally collected data, this information may be reported to the user. Depending on the embodiment, the reporting of the reply may include the same information that is included in the reply, or may include more information, less information and/or different information than in the reply. For example, in some cases the requesting system may retrieve data from memory (e.g. memory 215 or 627) to supplement the information received in the reply and present the supplemental information along with information received in the reply to the associated user. Continuing with the example and assuming the requesting system is sending system 110 and the reply includes information on messages for which receipt notifications were not received, sending system 110 may retrieve supplemental information from memory 215 for presentation to the user. As another example, in some cases, additionally or alternatively, the requesting system may report less detail than included in the reply, for example reporting only sufficient information to allow the associated user to make a decision on whether or not to send a new request. As another example, in some cases, additionally or alternatively, the requesting system may receive message identifiers in the reply and may substitute for the message identifiers information on the messages retrieved from memory (e.g. memory 215 or 627) and may report the substituted information to the user instead of the identifiers.

If instead the reply is not to be reported (no to stage 1010), then in the illustrated embodiments stage 1012 is skipped.

In the illustrated embodiments in stage 1014, it is determined if a new request related to the reply is desired. The determination may be based on user input or may be determined automatically by the requesting system.

If it is determined that a new request is desired (yes to stage 1014), then in the illustrated embodiments in stage 1016 a new request related to the reply is sent to tracking system 140. As in the initial request, embodiments of the invention do not limit the messages, data, and/or actions relating to the follow up request, but for further illustration to the reader some examples are now given. For example, in some cases if the reply included a report, the new request may relate to the content of the report. Continuing with the example, if the report included messages for which receipt notifications were not received, then the new request may request resending of those messages. As another example, if the reply included a confirmation of the follow up action of resending the messages, the new request may relate to whether or not receipt notification was received for the resent messages. In the illustrated embodiments, after stage 1016 method 1000 iterates back to stage 1004 to determine if a reply is received for the new request.

In the illustrated embodiments, if instead no new request related to the reply is desired (no to stage 1014), then in the illustrated embodiments method 1000 ends.

It will also be understood that in some embodiments a system or part of a system according to the invention may be a suitably programmed machine. Likewise, some embodiments of the invention contemplate a computer program being readable by a machine for executing a method of the invention. Some embodiments of the invention further contemplate a machine-useable medium tangibly embodying program code readable by the machine for executing a method of the invention.

While the invention has been shown and described with respect to particular embodiments, it is not thus limited. Numerous modifications, changes and improvements within the scope of the invention will now occur to the reader.

1. A system for tracking sent messages, comprising:
a communicator operable to receive receipt notifications for sent messages;
an accessor operable to update receipt statuses of said messages; and
a follow up action performer operable to perform at least one action relating to at least one sent message for which a receipt notification was not received.

2. The system of claim 1, wherein said at least one action includes resending at least one message for which a receipt notification was not received.

3. The system of claim 2, wherein said at least one message is resent in a different manner than previously sent.

4. The system of claim 3, wherein said different manner includes resending a message to an intended receiving user using different contact information for said user than previously used in sending said message.

5. The system of claim 3, wherein said different manner includes resending a message to an intended receiving user using a different communication channel than previously used in sending said message.

6. The system of claim 3, wherein said follow up action performed is further operable to modify data in said message before resending in order to better accommodate said different manner.

7. The system of claim 1, wherein said at least one action includes reporting for at least one message that a receipt notification was not received for said message, or reporting for at least one resent message that said message was resent.

8. The system of claim 1, wherein said accessor is further operable to identify which sent message is associated with a received receipt notification based on an identifier included in said notification.

9. The system of claim 1, wherein said identifier was included in a message field that is presented to a receiving user in an inbox summary list.

10. The system of claim 1, wherein said communicator is further operable to receive messages from a sending system and forward said messages to intended receiving users.

11. A system for tracking a sent message, comprising:
a communicator operable to receive a receipt notification for a sent message, said notification including an indication of at least one characteristic of a receiving system which received said message.

12. The system of claim 11, further comprising:
a follow up action performer operable to report at least one characteristic of said receiving system to a sending user of said message.

13. The system of claim 11, wherein said at least one characteristic is selected from a group comprising: type of device, type of platform, type of operating system, browser version, Internet Protocol address, and unique device identifier.

14. The system of claim 11, wherein said system is further operable to identify which sent message is associated with a received receipt notification based on an identifier included in said notification.

15. The system of claim 11, wherein said identifier was included in a message field that is presented to a receiving user in an inbox summary list.

16. The system of claim 11, wherein said communicator is further operable to receive messages from a sending system and forward said messages to intended receiving users.

17. The system of claim 11, wherein said follow up action performer being operable to report said at least one characteristic of said receiving system to a system associated with a sending user of said message, in response to a request received from a system associated with said sending user.

18. A system for receiving a message, comprising:
a tracking information determiner operable to determine where to send a message receipt notification for a received message which is being tracked so that receipt status will be updated; and
a notification composer operable to compose said receipt notification, including an indication of at least one characteristic of said system, and operable to send said composed receipt notification to where tracking information determiner determined.

19. The system of claim 18, wherein said tracking information determiner is operable to determine where to send a receipt notification based on data included in said message.

20. The system of claim 18, wherein said system is further operable to delete a received message which is a duplicate.

21. A system for receiving messages, comprising:
a tracking information determiner operable to determine where to send receipt notifications for received messages which are being tracked so that receipt statuses will be updated for corresponding messages;
a notification composer operable to compose said receipt notifications and to send said composed receipt notifications to where tracking information determiner determined; and
a request handler operable to handle requests to a tracking system, said requests triggering actions relating to non-received messages intended for a receiving user associated with said receiving system.

22. The system of claim 21, wherein at least one of said actions includes resending at least one message for which no receipt notifications were received.

23. The system of claim 21, wherein said tracking information determiner is operable to determine where to send a receipt notification based on data included in said message.

24. The system of claim 21, wherein said system is further operable to delete a received message which is a duplicate.

25. A network for messaging, comprising:
a receiving system operable to receive a message which is being tracked and to send a receipt notification for said message; and
a tracking system operable to receive said receipt notification and update receipt status for said message, and further operable to perform at least one action relating to at least one sent message for which a receipt notification was not received.

26. A network for messaging, comprising:
a receiving system operable to receive a message which is being tracked and to send a receipt notification for said message, said notification including an indication of at least one characteristic of said receiving system; and
a tracking system operable to receive said notification.

27. A method of tracking sent messages, comprising:
becoming aware of messages sent by a sending system;
updating receipt statuses of sent messages for which receipt notifications have been received; and
upon a trigger, performing at least one action relating to sent messages for which receipt notifications have not been received.

28. A method of tracking a sent message, comprising:
receiving a receipt notification for a sent message, said notification including an indication of at least one characteristic of a receiving system which received said message.

29. A method of receiving a message, comprising:
determining where to send a message receipt notification for a received message which is being tracked so that receipt status will be updated;
composing said receipt notification, including an indication of at least one characteristic of said system; and
sending said composed receipt notification to where determined.

30. A method of receiving messages, comprising:
a receiving system receiving messages and sending receipt notifications for received messages;
sending a request to receive any messages which were sent but not received; and
receiving said previously non-received messages subsequent to said request.

31. A method of messaging, comprising:
a receiving system receiving a message which is being tracked and sending a receipt notification for said message;
receiving said receipt notification and updating receipt status for said message; and
performing at least one follow up action relating to at least one sent message for which a receipt notification was not received.

32. A method of messaging, comprising:
receiving a message which is being tracked;
sending a receipt notification for said message, said notification including an indication of at least one characteristic of a receiving system which received said message; and
receiving said receipt notification.

33. A computer program product comprising a machine useable medium having machine readable program code embodied therein for tracking sent messages, the computer program product comprising:
machine readable program code for causing the machine to become aware of messages sent by a sending system;
machine readable program code for causing the machine to update receipt statuses of sent messages for which receipt notifications have been received; and
machine readable program code for causing the machine upon a trigger, to perform at least one action relating to sent messages for which receipt notifications have not been received.

34. A computer program product comprising a machine useable medium having machine readable program code embodied therein for tracking a sent message, the computer program product comprising:
machine readable program code for causing the machine to receive a receipt notification for a sent message, said notification including an indication of at least one characteristic of a receiving system which received said message.

35. A computer program product comprising a machine useable medium having machine readable program code embodied therein for receiving a message, the computer program product comprising:
machine readable program code for causing the machine to determine where to send a message receipt notification for a received message which is being tracked so that receipt status will be updated;
machine readable program code for causing the machine to compose said receipt notification, including an indication of at least one characteristic of said system; and
machine readable program code for causing the machine to send said composed receipt notification to where determined.

36. A computer program product comprising a machine useable medium having machine readable program code embodied therein for receiving messages, the computer program product comprising:
machine readable program code for causing the machine to receive messages and send receipt notifications for received messages;
machine readable program code for causing the machine to send a request to receive any messages which were sent but not received; and
machine readable program code for causing the machine to receive said previously non-received messages subsequent to said request.
